(19) United States
(12) Patent Application Publication
(10) Pub. No.: US 2026/0025829 A1
(43) Pub. Date: Jan. 22, 2026

(54) SYSTEMS AND METHODS FOR CELL SWITCHING COMMAND CONSTRUCTION AND USE

(71) Applicant: APPLE INC., Cupertino, CA (US)

(72) Inventors: Hong He, San Jose, CA (US); Seyed Ali Akbar Fakoorian, San Diego, CA (US); Dawei Zhang, Saratoga, CA (US); Oghenekome Oteri, San Diego, CA (US); Wei Zeng, San Diego, CA (US); Chunxuan Ye, San Diego, CA (US)

(21) Appl. No.: 19/145,141

(22) PCT Filed: Jan. 31, 2024
(86) PCT No.: PCT/US2024/013646

§ 371 Date: Jul. 1, 2025

Related U.S. Application Data
(60) Provisional application No. 63/484,813, filed on Feb. 14, 2023.

(51) Int. Cl. H04W 72/23; H04W 24/10; H04W 72/21; H04W 74/0838; H04W 76/38

(52) U.S. Cl. CPC H04W 72/23; H04W 24/10; H04W 72/21; H04W 74/0838; H04W 76/38

(57) ABSTRACT

Systems and methods for signaling of Layer 1 (L1)/Layer 2 (L2) triggered mobility and timing management for wireless communications are described herein. In some embodiments, a user equipment (UE) receives a cell switching command as a combination of a downlink control information (DCI) and a medium access control control element (MAC-CE) that corresponds to that DCI. In some embodiments, a same set of transmission configuration indicator (TCI) state IDs is used with respect to all candidate cells of a sub-candidate cell group (CCG) of a configured CCG. In some embodiments, MAC-CEs are used to inform the UE of timing advance (TA) information using timing advance group (TAG)-specific physical cell identity (PCI) indexes for candidate cells of the TAG that correspond to full PCIs for those candidate cells.

### TECHNICAL FIELD

This application relates generally to wireless communication systems, including wireless communication systems supporting Layer 1 (L1)/Layer 2 (L2) triggered mobility and timing management.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-FiR).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a MAC-CE format used as part of an LTM cell switching command, according to embodiments herein.

FIG. 2 illustrates a table showing definitions of values that may be found in a TA usage field of a MAC-CE format, according to embodiments herein.

FIG. 3 illustrates a diagram of one example of a use of a MAC-CE and a subsequent DCI to effectuate a cell switching command for LTM, according to embodiments herein.

FIG. 4 illustrates a diagram illustrating the beam information indication for candidate cells in a target CCG under the first option, according to embodiments herein.

FIG. 5 illustrates a diagram illustrating the beam information indication for candidate cells in a target CCG under the second option, according to embodiments herein.

FIG. 6A illustrates an example of an RAR MAC-CE for LTM procedures, according to embodiments herein.

FIG. 6B illustrates an example of a TAC MAC-CE for LTM procedures, according to embodiments herein.

FIG. 7 illustrates an example of a single shared TAG used between candidate cells in LTM operation in accordance with approaches described herein.

FIG. 8 illustrates a method of a UE, according to embodiments herein.

FIG. 9 illustrates a method of a RAN, according to embodiments herein.

FIG. 10 illustrates a method of a UE, according to embodiments herein.

FIG. 11 illustrates a method of a RAN, according to embodiments herein.

FIG. 12 illustrates a method of a UE, according to embodiments herein.

FIG. 13 illustrates a method of a RAN, according to embodiments herein.

FIG. 14 illustrates a method of a UE, according to embodiments herein.

FIG. 15 illustrates a method of a RAN, according to embodiments herein.

FIG. 16 illustrates a method of a UE, according to embodiments herein.

FIG. 17 illustrates a method of a RAN, according to embodiments herein.

FIG. 18 illustrates a method of a UE, according to embodiments herein.

FIG. 19 illustrates a method of a RAN, according to embodiments herein.

FIG. 20 illustrates an example architecture of a wireless communication system, according to embodiments disclosed herein.

FIG. 21 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Wireless communications services (e.g., mobile services) designed for low-latency and high reliability performance (e.g., ultra reliable and low latency communications (URLLC)) are emerging. While some wireless communication standards (e.g., some 5G standards) have been designed to address these use cases, further evolution of these standards continues forward with the goal to enhance the mobility robustness performance for various challenging scenarios.

In some circumstances, it may be beneficial to implement Layer 1 (L1) enhancements related to inter-cell beam management, including, for example, aspects of L1 measurement and reporting and/or beam indication. However, in some contexts, the exact nature of information/contents provided by a cell switching command for L1/Layer 2 (L2) mobility (LTM) cases and corresponding parameters may be undefined for various use cases.

Further, for cases of L1/L2 inter-cell mobility, it may be that a UE is first configured with candidate target cells for L1/L2 mobility, and then, during an execution of a L1/L2 mobility serving cell change, the UE switches to these candidate target cells in a simultaneous fashion. In this context, it may be beneficial to indicate beam information for each of the candidate cells in a manner that minimizes or reduces signaling overhead.

Finally, in the case of timing advance (TA) management in LTM operation, various improvements may be possible. For example, a wireless communication system may be configured to support acquisition of TA information (e.g., a TA offset value) for one or more candidate cell(s) before a cell switch command is received according to an LTM procedure. Note that it may be typical in such cases that a large amount of candidate cells are configured for L1 measurements report (such that the best cell can be selected by network for handover). Assigning one timing advance group (TAG) per each candidate cell under such circumstances would result in a use of a significantly increased number of TAG numbers (and associated signaling) and accordingly may not be preferable. Discussion herein accordingly relates to development of TA management schemes for LTM that can be used to maintain TA offset values associated with non-serving cells of a UE and that target a minimized specification impact and/or signaling overhead.

### Embodiments of Cell Switching Command Construction

According to certain aspects of this disclosure, the following mechanisms may be considered for providing beam information for target cells in LTM operation in the case that a transmission configuration indicator (TCI) state list has been pre-configured by radio resource control (RRC) signaling for a special cell (SpCell) prior to the cell-switching command reception.

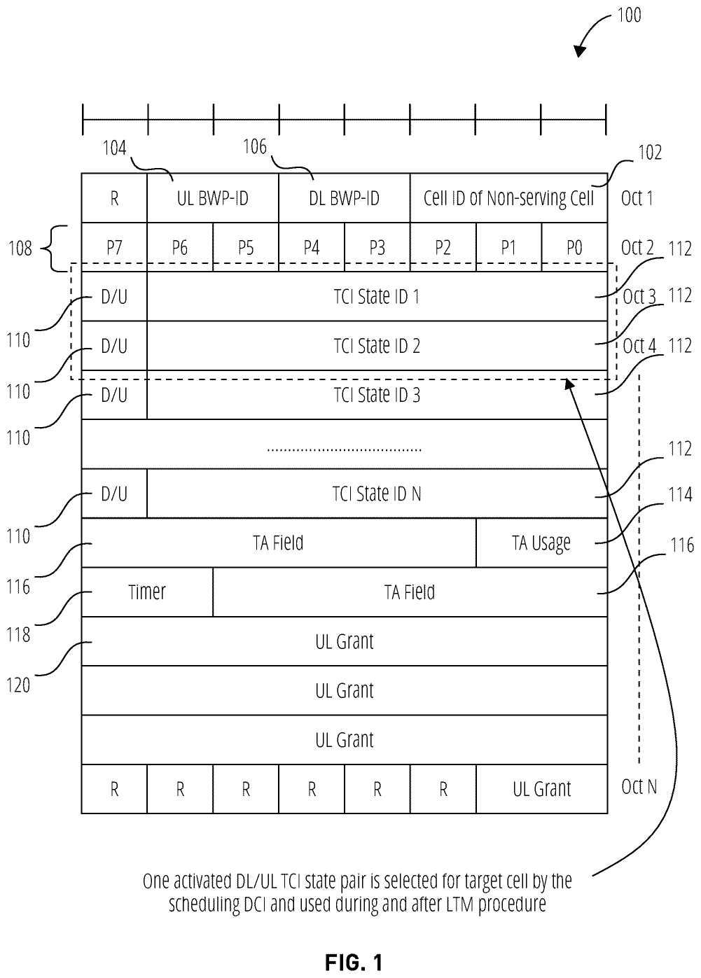

In a first alternative for a construction for a cell switching command, a combination of a scheduling downlink control information (DCI) and a corresponding medium access control control element (MAC-CE) may be considered (in combination) as an LTM cell switching command. In such cases, a corresponding MAC-CE format for the MAC-CE may be used. For example, FIG. 1 illustrates a MAC-CE format 100 used as part of an LTM cell switching command, according to embodiments herein. A discussion of fields that may be used as part of the MAC-CE format 100 now follows.

The MAC-CE format 100 may include a non-serving cell ID field 102, which indicates the identity of a target non-serving cell ID. In other words, this value of the non-serving cell ID field 102 identifies, to the UE, the non-serving cell for which the rest of the information in the MAC-CE format 100 applies.

The MAC-CE format 100 may further includes an uplink (UL) bandwidth part (BWP) identifier (ID) field 104 and a downlink (DL) BWP ID field 106. These fields identify target frequency resources corresponding to the identified non-serving cell in respectively the UL and DL contexts. Note that in some designs, a single DL and UL BWP may be pre-configured and used during an LTM procedure. In such cases, the UL BWP ID field 104 and/or the DL BWP ID field 106 may be optional.

MAC-CE content related to TCI states with respect to the target non-serving cell are now discussed. The MAC-CE format 100 may further include one or more Pi fields 108, where each of the Pi fields 108 corresponds to a TCI codepoint that may be received in the scheduling DCI corresponding to the MAC-CE format 100. In the MAC-CE format 100, there are eight Pi fields 108, anticipating the possibility that a received TCI codepoint may take one of eight possible values. Each of the Pi fields 108 may indicate, for its corresponding one of the TCI codepoints, whether that TCI codepoint is associated with one of the TCI state ID fields 112 or whether it is associated with two of the TCI state ID fields 112. This may be used in cases where, for example, the non-serving cell of the MAC-CE format 100 is understood to operate in the context of a separate TCI states mode. As indicated, the Pi fields 108 may be 1-bit fields.

The MAC-CE format 100 may further include one or more D/U fields 110 and one or more corresponding TCI state ID fields 112. The D/U fields 110 indicate, for a corresponding one of the TCI state ID fields 112 (e.g., a TCI state ID field in the same octet as a D/U field), whether the TCI state ID indicated in the TCI state ID field is understood to relate to a DL TCI state or an UL TCI state of a TCI state list for the non-serving cell corresponding to the MAC-CE format 100. As illustrated, the D/U fields 110 may be 1-bit fields.

The TCI state ID fields 112 indicate a selection of TCI state indexes/activated TCI states selected from a TCI state list corresponding to the non-serving cell (e.g., that may have been previously provided to the UE via RRC signaling). In other words, these TCI state indexes are configured to identify particular ones of a TCI state list associated with the non-serving cell of the MAC-CE format 100.

In some embodiments, it may be that an activated DL/UL TCI state pair is selected by a TCI codepoint in a TCI field in the scheduling DCI format that schedules a (e.g., later) MAC-CE physical downlink shared channel (PDSCH) transmission using the MAC-CE format 100. This TCI state pair may then be used for DL reception and UL transmission during (and after) an LTM procedure with respect to the non-serving cell (e.g., during a handover to the non-serving cell). An example of such a selection of a TCI state pair has been illustrated in FIG. 1.

MAC-CE content related to UL TA information is now discussed. The MAC-CE format 100 may further include a TA usage field 114 and a TA field 116. The TA usage field 114 may indicate a usage of a TA field 116.

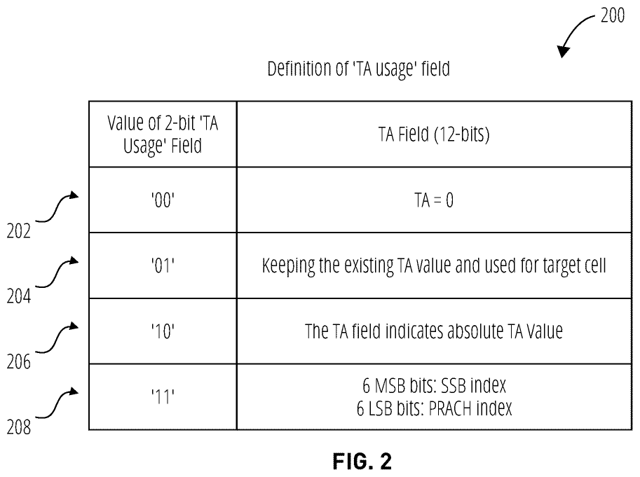

FIG. 2 illustrates a table 200 showing definitions of values that may be found in the TA usage field 114 of the MAC-CE format 100, according to embodiments herein. Note that in embodiments such as those anticipated in FIG. 1 and FIG. 2, where a TA usage field can define one of four possible uses of the TA field 116, the TA usage field 114 may accordingly use two bits. Further, it is anticipated that the TA field 116 may be 12 bits.

In a first case 202, the TA usage field 114 may take a value of “00.” This may indicate to the UE that the UE is to perform UL transmission during a handover to the non-serving cell without using any TA offset value. No particular usage of the TA field 116 may be understood in this case.

In a second case 204, the TA usage field 114 may take a value of “01.” This may indicate to the UE that the UE is to perform UL transmission during a handover to the non-serving cell using a currently (e.g., previously existing) configured/understood TA offset value for the non-serving cell. No particular usage of the TA field 116 may be understood in this case.

In a third case 206, the TA usage field 114 may take a value of “10.” This may indicate to the UE that the bits (e.g., the 12 bits) of the TA field 116 are to be understood to indicate a specified (e.g., absolute) TA offset value that is to be used by the UE for UL transmission during communications with (e.g., handover to) the non-serving cell. In such cases, the network accordingly provides the specified TA offset value in the TA field 116.

In a fourth case 208, the TA usage field 114 may take a value of “11.” This may indicate to the UE that the bits of the TA field 116 provide configuration information with respect to a contention free random access (CFRA) procedure to be performed by the UE with the non-serving cell to determine a TA offset value to use to communicate with the non-serving cell. In such a case, the network may provide a synchronization signal block (SSB) index in a first portion of the TA field 116 (e.g., in the six most significant bits (MSB) of the TA field 116) and a physical random access channel (PRACH) index in a second portion of the TA field 116 (e.g., the six least significant bits (LSB) of the TA field 116).

The SSB index may be used to select a plurality of PRACH resources for the CFRA procedure and to determine a spatial relation for a PRACH transmission of the CFRA procedure. Further, the PRACH index may be used to select a PRACH resource from the plurality of PRACH resources for the PRACH transmission.

Then, as part of the CFRA procedure that occurs between the UE and the non-serving cell as configured according to this information, the UE determines a TA offset value that may be used by the UE for UL transmission during communications with (e.g., a handover to) the non-serving cell.

Returning to FIG. 1, the MAC-CE format 100 may further include a timer field 118. This timer field 118 may carry a timer value for a timer that is started at the UE at the time of the reception of a MAC-CE of the MAC-CE format 100 as part of a cell switching command, and that is disabled/cancelled at the time of a successful handover of the UE to the non-serving cell. In the alternative case where this timer instead expires, the expiration may trigger the UE to initiate an RRC re-establishment procedure with (or to fall back to) the (e.g., prior-to-attempted-handover) serving cell going forward. Accordingly, it may be understood that the timer field 118 provides a timer value for use in determining whether the handover to the non-serving cell has failed.

The MAC-CE format 100 may further include a UL grant field 120. The UL grant field 120 may provide a resource allocation for the UE on the non-serving cell. In other words, the UL grant field 120 may identify resources useable by the UE for UL transmission on the non-serving cell.

In alternative embodiments to those using a scheduling DCI and a MAC-CE format 100, it may be that a MAC-CE contains only a single pair of DL/UL TCI states or a single reference signal (RS) index to be used for LTM operation. This configuration may not use a scheduling DCI to specify a TCI state pair, as in such cases the MAC-CE contains only one resolvable/usable pair of TCI states/a single RS index to use with the other configuration parameters as provided.

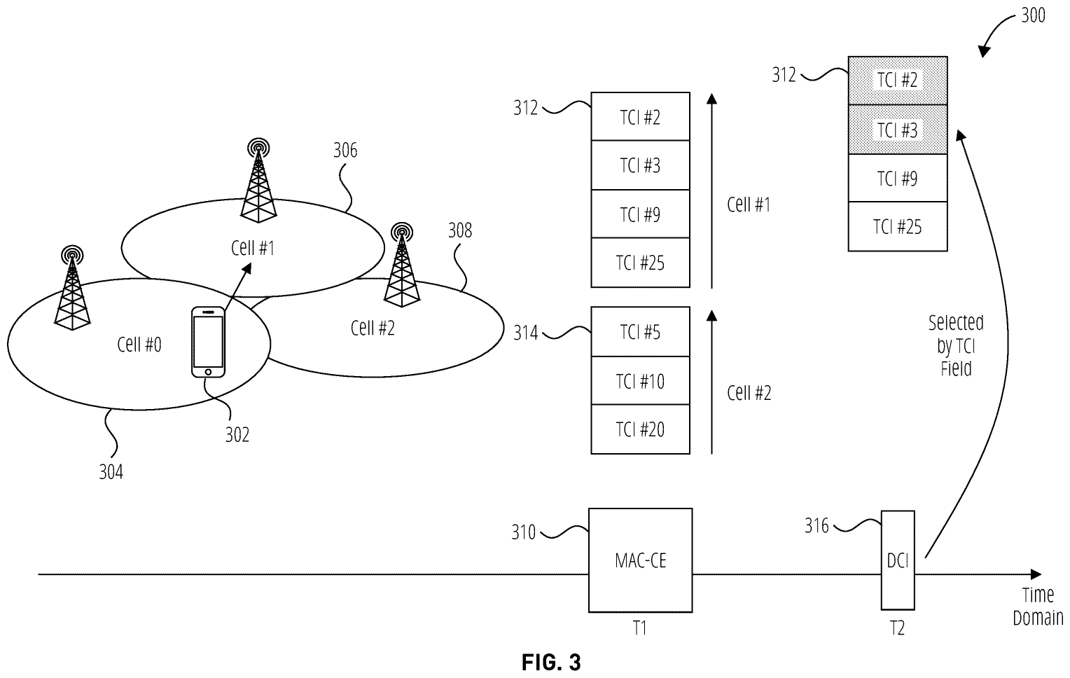

In a second alternative for a construction for a cell switching command, a combination of a MAC-CE and a subsequent DCI may be considered (in combination) as an LTM cell switching command. For example, FIG. 3 illustrates a diagram 300 of one example of a use of a MAC-CE and subsequent DCI to effectuate a cell switching command for LTM, according to embodiments herein.

Under the second alternative, a MAC-CE maybe introduced to provide mobility trigger information with respect to a plurality of candidate cells. This MAC-CE may be received at the UE on a PDSCH scheduled according to a scheduling DCI previously received at the UE (this scheduling DCI is not shown in FIG. 3). One or more items of information in this MAC-CE may be as was described in relation to the MAC-CE format 100 of FIG. 1.

Then, a separate (e.g., subsequent in time to the MAC-CE) DCI may be used to trigger the LTM cell switching operation with a selected candidate cell. This DCI may down-select one TCI state pair (or DL RS) from the activated TCI states/DL RSs associated with the selected candidate cell as activated by the MAC-CE, and may further include a physical cell identity (PCI) or virtual ID of the selected candidate cell. This information enables the UE to perform a handover to the identified candidate serving cell using the selected TCI state pair.

This DCI may also inform the UE of a (e.g., an absolute) TA offset value to be used for UL communication with the selected candidate cell. In some embodiments, a TA offset value associated with the selected candidate cell maybe provided directly by the DCI by repurposing reserved bits (e.g., in the case a fallback DCI 1_0 format is used) or by adding a new field to the DCI (e.g., in the case that a DCI format 1_1 is used).

FIG. 3 assumes the case where a UE 302 is performing a handover from a source cell 304, and that there are two candidate cells, the first candidate cell 306 and the second candidate cell 308, from which the UE may select with which to perform the handover.

In the illustrated example embodiment of FIG. 3, one or more items of information found in the MAC-CE format 100 may be delivered for each of the first candidate cell 306 and the second candidate cell 308 in respective sub-blocks of the MAC-CE 310, which is received at the UE at T1 as indicated. The first sub-block 312 of the MAC-CE 310 corresponds to the first candidate cell 306 and indicates four activated TCI states for the first candidate cell 306 (e.g., in the manner as was described in relation to the MAC-CE format 100). Further, the second sub-block 314 of the MAC-CE 310 corresponds to the second candidate cell 308 and indicates three activated TCI states for the second candidate cell 308 (e.g., also in the manner as was described in relation to the MAC-CE format 100).

Then, at time T2, a DCI 316 (e.g., of a separate DCI format) is used to trigger the LTM procedure to the first candidate cell 306 (e.g., by identifying the PCI of the first candidate cell 306) and to select a TCI state pair (e.g., TCI #2 and the TCI #3, as indicated in FIG. 3) from the four activated TCI for the first candidate cell 306. The selected TCI state pair may be used for DL reception and UL transmission. Note that the DCI 316 may also provide an (e.g., absolute) TA offset value for use with UL communication by the UE 302 with the first candidate cell 306.

### Embodiments for Beam Indication for Candidate Cells within a Candidate Cell Group

In some embodiments, a UE may be provided a list of candidate cell groups (CCGs) by RRC signaling prior to a cell switching command, where each CCG includes at least one SpCell and one or more secondary cells (SCells) as candidate cells. In such circumstances, various approaches may be considered to efficiently indicate beam information for candidate cells in a CCG using a reduced amount of corresponding signaling.

As a first step, the network may configure the candidate cells of the CCG into different sub-CCGs. This may be done using, for example, an RRC message from the network to the UE.

Then, a pair of options may be considered to update TCI states simultaneously for all candidate cells within a sub-CCG.

A first such option uses a shared TCI state ID update for all candidate cells in a sub-CCG. Under the first option, individual TCI state lists are/have been configured by the network for each candidate cell in the sub-CCG (e.g., via RRC signaling). Then, whenever a set of TCI state IDs are received in a MAC-CE for any candidate cell in the sub-CCG, the same set of TCI state IDs are activated with respect to all candidates within the sub-CCG (e.g., each candidate cell uses these (same) TCI state IDs to identify activated TCI states from its corresponding TCI state list). The first option enables the network to configure for the use of different TCI states with different candidate cells using a single set of TCI state IDs (reducing signaling overhead with respect the case where an independent set of TCI state IDs is signaled for each candidate cell in the sub-CCG).

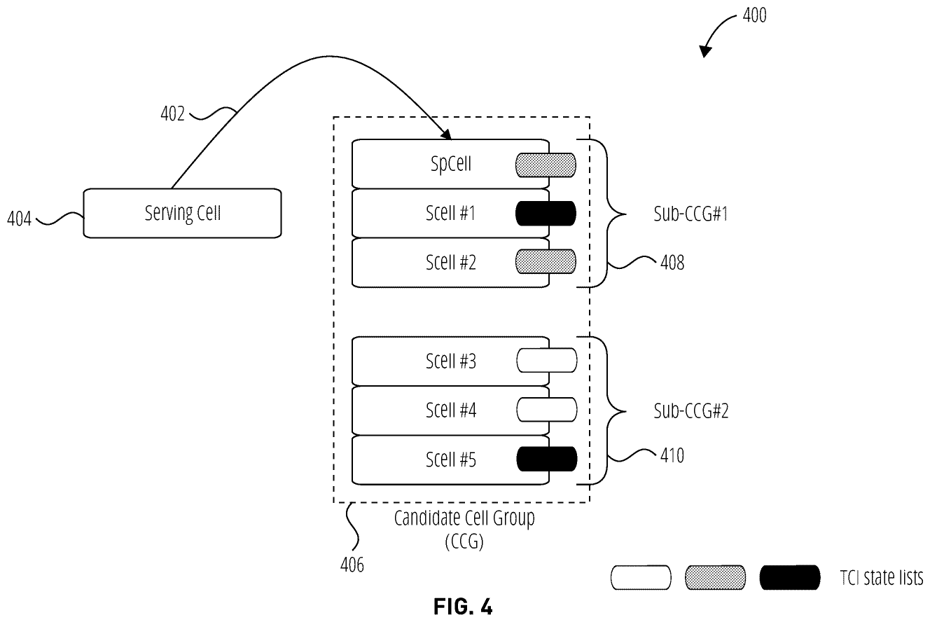

FIG. 4 illustrates a diagram 400 illustrating the beam information indication for candidate cells in a target CCG under the first option, according to embodiments herein. FIG. 4 assumes the case of a handover 402 from a serving cell 404 to a SpCell of a CCG 406, as illustrated. FIG. 4 illustrates six candidate cells in the in the CCG, which have been divided into the first sub-CCG 408 and the second sub-CCG 410 (each having three of the candidate cells). This division may be informed to the UE by the network in configuration information provided to the UE by the network. Note that this arrangement (e.g., the overall number of candidate cells in the CCG, the number of sub-CCGs, and the particular division of the candidate cells into the sub-CCGs/number of candidate cells in each sub-CCG) is given by way of example and not by way of limitation.

In FIG. 4, an individual TCI state list has been independently configured for each candidate cell. Note that in this case, the TCI state lists for each candidate cell may be arbitrary with respect to an LTM cell switching scheme (as illustrated).

Then, a MAC-CE of a LTM cell switching command may be received at the UE. This MAC-CE may indicate (directly) one or more TCI state IDs for a candidate cell of the CCG. In the case of FIG. 4, it may be that the MAC-CE received corresponds to the SpCell (but this is not required). In such a cases, the TCI state IDs activated directly in the MAC-CE for the SpCell are also be applicable to the other candidate cells in the sub-CCG of the SpCell (the other candidate cells in the first sub-CCG 408). Accordingly, the UE uses those same TCI state IDs to activate TCI states for Scell #1 and the Scell #2 based on an application of those same TCI state IDs to the respective TCI state lists for each of Scell #1 and Scell #2.

It will be further understood that if a second MAC-CE is received identifying TCI state IDs for use with a candidate cell of a second sub-CCG (e.g., for Scell #3 on the second sub-CCG 410), an analogous procedure would be used to determine TCI states for each of the candidate cells of the second sub-CCG using those same TCI state IDs with respect to individual TCI state lists for each candidate cell in that sub-CCG (e.g., those same TCI state IDs would be applied with the individual TCI state lists for the Scell #3, Scell #4, and Scell #5).

Under a second option, unlike the first option, a single TCI state list for one candidate cell per sub-CCG is used. These TCI state lists may be configured at the UE via RRC signaling. Then whenever TCI state IDs are indicated a MAC-CE (e.g., corresponding to an LTM cell switching command) for a candidate cell configured with a TCI state list, the activated TCI states selected from the TCI state list based on these TCI state IDs are applied with respect to all the candidate cells in a same sub-CCG. This further reduces network signaling over the case of the first option, because only one TCI state list per sub-CCG needs to be configured (as opposed to an individual TCI state list being configured each candidate cell of the sub-CCG).

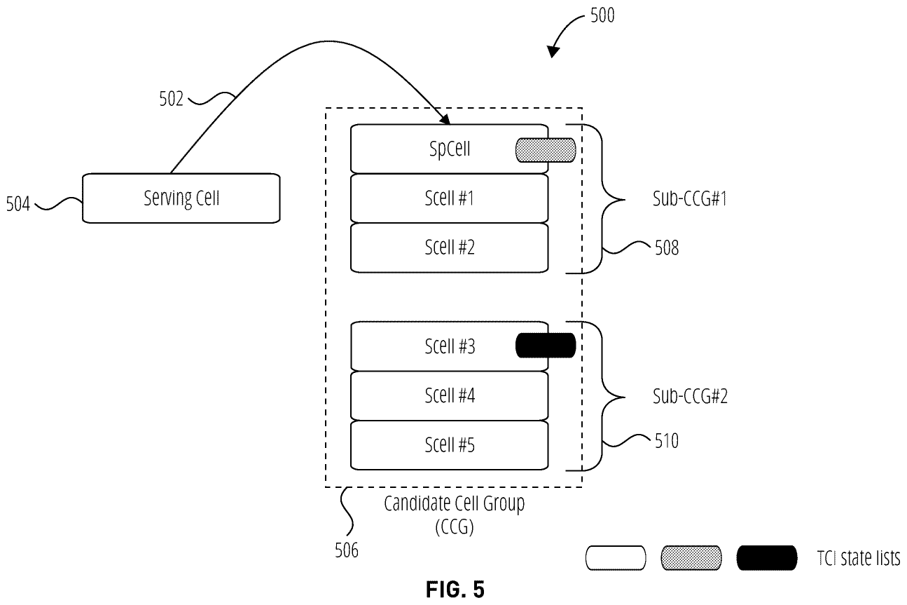

FIG. 5 illustrates a diagram 500 illustrating the beam information indication for candidate cells in a target CCG under the second option, according to embodiments herein. FIG. 5 assumes the case of a handover 502 from a serving cell 504 to a SpCell of a CCG 506, as illustrated. FIG. 5 illustrates six candidate cells in the in the CCG, which have been divided into the first sub-CCG 508 and the second sub-CCG 510 (each having three of the candidate cells). This division may be informed to the UE by the network in configuration information provided to the UE by the network. Note that this arrangement (e.g., the overall number of candidate cells, the number of sub-CCGs, and the particular division of the candidate cells into the sub-CCGs/number of candidate cells in each sub-CCG) is given by way of example and not by way of limitation.

In FIG. 4, an individual TCI state list has been independently configured for one cell of the first sub-CCG 508 (the SpCell) and one cell of the second sub-CCG 510 (Scell #3). Note that the TCI state lists for these cells may be arbitrary with respect to an LTM cell switching scheme (as illustrated). Note also that in other embodiments, a TCI state list may instead be configured for another cell of the first sub-CCG 508 (e.g., the Scell #1 or the Scell #2).

Then, a MAC-CE of a LTM cell switching command may be received at the UE. This MAC-CE may indicate (directly) one or more TCI state IDs for one of the candidate cells having a configured TCI state list. In the case of FIG. 4, it may be that the MAC-CE received corresponds to the SpCell (but this is not required, as a MAC-CE in this context could correspond instead to Scell #3). In such a case, the UE uses the indicated TCI state IDs to activate TCI states for the SpCell based on the TCI state list for the SpCell. Further, because Scell #1 and Scell #2 are in the same sub-CCG as the SpCell (the first sub-CCG 508), these same TCI states are (also) understood to be activated with respect to Scell #1 and the Scell #2.

It will be further understood in such embodiments that if a second MAC-CE is received identifying TCI state IDs for use with the cell of the second sub-CCG (e.g., the second sub-CCG 510) that is configured with the TCI state list (e.g., for Scell #3) to activate TCI states on that list, any such activated TCI states would (also) be considered active for the other cells of the second sub-CCG (e.g., each of Scell #3, Scell #4, and Scell #5).

### Embodiments of Enhanced Timing Management for Candidate Cells in LTM

According to certain aspects of this disclosure, various approaches for managing UL TA offset values for non-serving cells (e.g., on a same frequency layer) may be introduced.

First, a configuration message (e.g., an RRC configuration message) from the network to the UE may identify that multiple candidate cells on a shared a frequency layer share a single TAG. The TAG is identified by a dedicated TAG-ID in the configuration message.

Each candidate cell in the group of candidate cells may correspond to a PCI index that is known to the UE to correspond to a (full) PCI for that same candidate cell. These PCI indexes may be communicated from the network to the UE in configuration signaling. For example, in some cases, one or more PCI indexes for one or more of the candidate cells in the TAG may be provided in the same configuration message that indicates the TAG-ID for the TAG. Alternatively, additional configuration message(s) may be used to provide the UE with PCI index(es) for one or more of the cells in the TAG. It is also contemplated that configuration signaling may also be so used to update a PCI index for a candidate cell in an analogous manner.

Then, a MAC-CE may be sent between the network and the UE to provide either an initial TA offset value or an update for/to a TA offset value for one of the group of candidate cells. The MAC-CE may indicate the TAG-ID for the group of cells and (additionally) a PCI index that corresponds to the one of the group of cells.

The MAC-CE used may be identified by a medium access control (MAC) subheader having a dedicated logical channel ID (LCID) corresponding to a one of a random access response (RAR) MAC-CE and a TA Command (TAC) MAC-CE (each of which may have a fixed size).

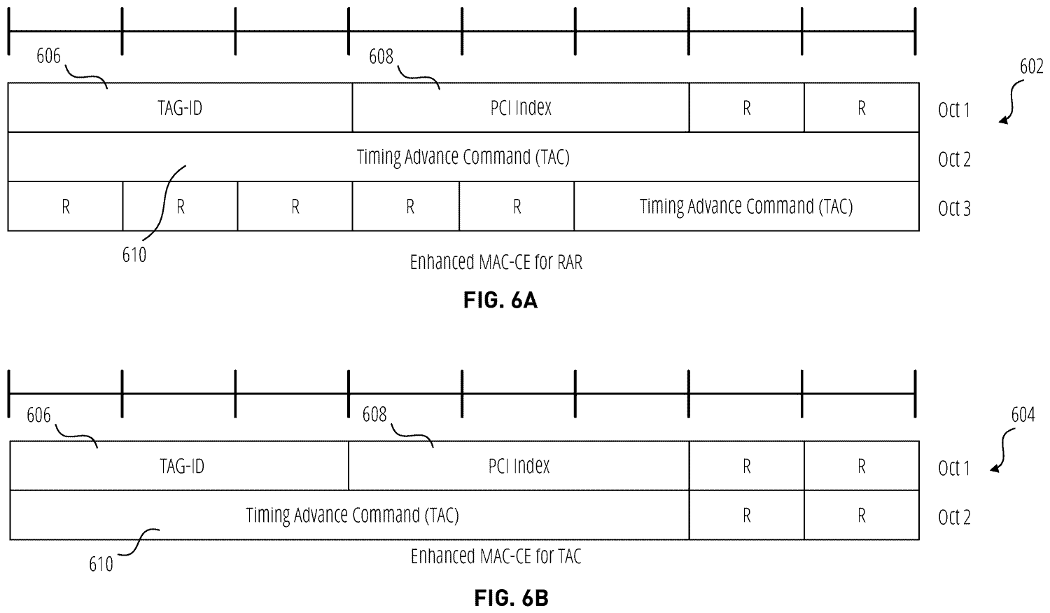

FIG. 6A illustrates an example of an RAR MAC-CE 602 for LTM procedures, according to embodiments herein. FIG. 6B illustrates an example of a TAC MAC-CE 604 for LTM procedures, according to embodiments herein. Fields that may appear in these MAC-CEs will now be discussed.

The RAR MAC-CE 602 and/or the TAC MAC-CE 604 can implement a TAG-ID field 606. The TAG-ID field 606 indicates a TAG-ID for the TAG for which the MAC-CE applies.

The RAR MAC-CE 602 and/or the TAC MAC-CE 604 can implement a PCI index field 608. The PCI index field 608 indicates a PCI index for the particular non-serving cell within the TAG for which the MAC-CE applies. The UE may be aware of a correspondence between (full) PCIs of the candidate cells and PCI indexes for the candidate cells based on previously received configuration signaling (e.g., RRC signaling).

The RAR MAC-CE 602 and/or the TAC MAC-CE 604 can implement a TAC field 610. The TAC field 610 may be used by the UE to determine a TA offset value for the particular non-serving cell within the TAG for which the MAC-CE applies. Note that in the example of FIG. 6A, the RAR MAC-CE 602 uses a TAC field 610 that is 11 bits wide, while in the example of FIG. 6B, the TAC MAC-CE 604 uses a TAC field 610 that is 6 bits wide. This may correspond to different uses for each of the RAR MAC-CE 602 and the TAC MAC-CE 604. For example, it may be that the RAR MAC-CE 602 is used to deliver an absolute TA offset value in its TAC field 610 (requiring relatively more bits), while the TAC MAC-CE 604 is used to deliver a TA offset adjustment value (that is applied with an existing TA offset value to determine an adjusted TA offset value) in its TAC field 610 (requiring relatively fewer bits).

Upon receiving the RAR MAC-CE 602 or the TAC MAC-CE 604, the UE is enabled to identify the candidate cell to which the RAR MAC-CE 602 or the TAC MAC-CE 604 applies through the application of the TAG-ID for a TAG represented in the TAG-ID field 606 and the known correspondence between the PCI index from the PCI index field 608 to a (full) PCI for a non-serving cell within that TAG corresponding to that PCI index. The TAC of the TAC field 610 can then be applied with respect to the identified candidate cell (e.g., an appropriate TA offset value may be established and/or updated for the identified candidate cell based on the TAC of the TAC field 610).

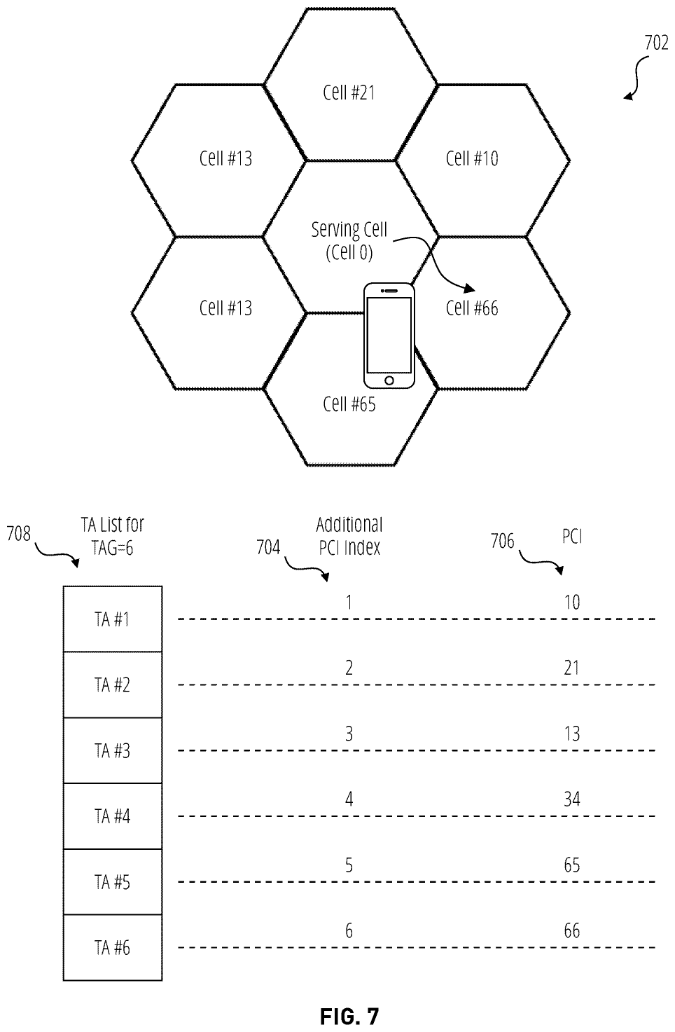

FIG. 7 illustrates an example of a single shared TAG 702 used between candidate cells in LTM operation in accordance with approaches described herein. The example of FIG. 7 assumes that the UE is currently served on a cell with a (full) PCI #0, and that there are 6 non-serving cells with (full) PCIs #10, #21, #13, #34, #65 and #66 that are all on the same frequency layer.

First, the network may assign TAG=6 for this frequency layer (as illustrated) such that it is shared by all the illustrated non-serving cells for TA management purposes. Further, it may be that PCI index values 704 have been configured respective to each of the (full) PCIs 706 of the non-serving cells of the TAG (e.g., via RRC signaling), as depicted in FIG. 7.

Then, the network may trigger a physical downlink control channel (PDCCH)-ordered CFRA procedure and provide a TA for one or more of the non-serving cells using, e.g., an RAR MAC-CE and/or a TAC MAC-CE. At the UE side, a TA list 708 is created to store any such received/updated TA values for the different non-serving cells with respect to these MAC-CE(s) (e.g., in an increasing order of PCI index value, as illustrated). This list may be associated with TAG=6 (e.g., based on the TAG-ID field of the received RAR MAC-CE(s) and/or TAC MAC-CE(s)).

Later, when the UE receives a cell switch command (e.g., in a second MAC-CE) indicating LTM towards the cell of PCI #66 in TAG=6, the UE identifies a TA value to use with respect to communication (e.g., handover) with PCI #66 from the TA list 708 (which is for TAG=6) based on the known correspondence between the PCI #66 used in the second MAC-CE and the first PCI index that was used in the first MAC-CE to generate/update the corresponding entry in the TA list 708.

Note that with this approach, there is no need to include a TA value or a TAG-ID in the (second) cell-switching command MAC-CE. Accordingly, efficiency of signaling within the system is promoted.

Finally, note that while discussion herein relates to the delivery of TACs within a group of candidate cells (e.g., in the context of TA offset values used for communication by the UE with one of the candidate cells), this is given by way of example and not by way of limitation. It will be understood that the described mechanism using mappings between a PCI index and a (full) PCI may be used for MAC-CE delivery of information other than TA information/handover information as between multiple cells of a TAG.

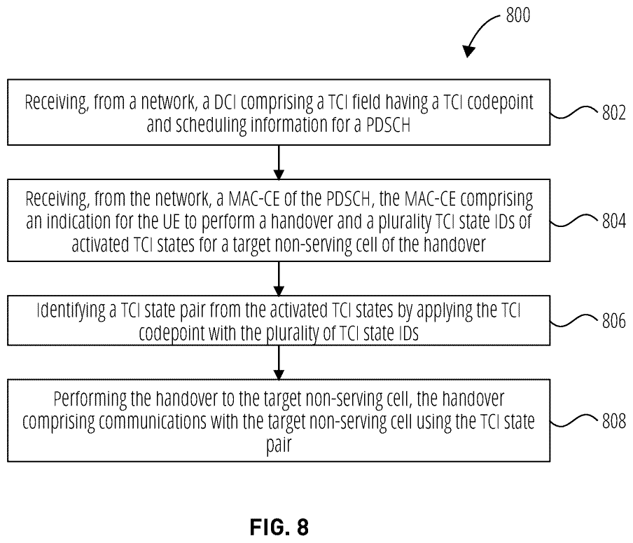

FIG. 8 illustrates a method 800 of a UE, according to embodiments herein. The method 800 includes receiving 802, from a network, a DCI comprising a TCI field having a TCI codepoint and scheduling information for a PDSCH.

The method 800 further includes receiving 804, from the network, a MAC-CE of the PDSCH, the MAC-CE comprising an indication for the UE to perform a handover and a plurality TCI state IDs of activated TCI states for a target non-serving cell of the handover.

The method 800 further includes identifying 806 a TCI state pair from the activated TCI states by applying the TCI codepoint with the plurality of TCI state IDs.

The method 800 further includes performing 808 the handover to the target non-serving cell, the handover comprising communications with the target non-serving cell using the TCI state pair.

In some embodiments of the method 800, the MAC-CE further comprises a cell ID for the target non-serving cell.

In some embodiments of the method 800, the MAC-CE further comprises an UL BWP ID and a DL BWP ID for the target non-serving cell.

In some embodiments of the method 800, the MAC-CE further comprises a bit indicating that the TCI codepoint is used to identify two of the plurality of TCI state IDs.

In some embodiments of the method 800, the MAC-CE further comprises a first value in a first 1-bit field indicating that a first TCI state of the TCI state pair is an UL TCI state and a second value in a second 1-bit field indicating that a second TCI state of the TCI state pair is a DL TCI state.

In some embodiments of the method 800, the MAC-CE further comprises a TA usage value in a TA usage field, the TA usage value indicating that a TA field in the MAC-CE is reserved and that the UE is to communicate with the target non-serving cell without using a TA offset value, and wherein the UE performs UL transmission during the handover to the target non-serving cell without using a TA offset value.

In some embodiments of the method 800, the MAC-CE further comprises a TA usage value in a TA usage field, the TA usage value indicating that a TA field in the MAC-CE is reserved and that the UE is to communicate with the target non-serving cell based on a currently configured TA offset value for the target non-serving cell, and wherein the UE performs UL transmission during the handover to the target non-serving cell using the currently configured TA offset value for the target non-serving cell.

In some embodiments of the method 800, the MAC-CE further comprises: a TA usage value in a TA usage field, the TA usage value indicating that the UE is to communicate with the target non-serving cell using a specified TA offset value, the specified TA offset value in a TA field, and wherein the UE performs UL transmission during the handover to the target non-serving cell using the specified TA offset value.

In some embodiments of the method 800, the MAC-CE further comprises: a TA usage value in a TA usage field, the TA usage value indicating that the UE is to perform a CFRA procedure with the target non-serving cell to determine a TA offset value to use to communicate with the target non-serving cell, and a TA field, comprising: a SSB index in a first set of bits of the TA field, the SSB index useable by the UE as part of the CFRA procedure to select a plurality of PRACH resources and a spatial relation for a PRACH transmission, and a PRACH index in a second set of bits of the TA field, the PRACH index useable by the UE as part of the CFRA procedure to select a PRACH resource from the plurality of PRACH resources, wherein the UE performs the handover to the target non-serving cell using the TA offset value determined by performing the CFRA procedure.

In some embodiments of the method 800, the MAC-CE further comprises a timer value identifying a timer for use in determining whether the handover to the target non-serving cell has failed.

In some embodiments of the method 800, the MAC-CE further comprises an UL grant identifying resources useable by the UE for UL transmission on the target non-serving cell.

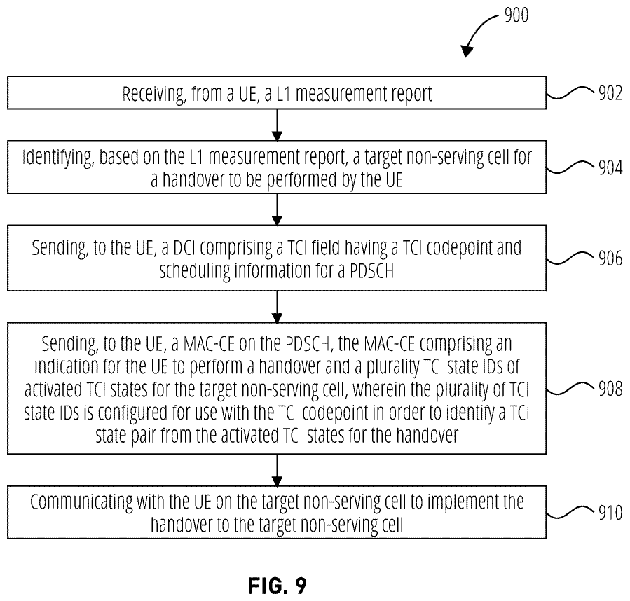

FIG. 9 illustrates a method 900 of a RAN, according to embodiments herein. The method 900 includes receiving 902, from a UE, an L1 measurement report.

The method 900 further includes identifying 904, based on the L1 measurement report, a target non-serving cell for a handover to be performed by the UE.

The method 900 further includes sending 906, to the UE, a DCI comprising a TCI field having a TCI codepoint and scheduling information for a PDSCH.

The method 900 further includes sending 908, to the UE, a MAC-CE on the PDSCH, the MAC-CE comprising an indication for the UE to perform a handover and a plurality TCI state IDs of activated TCI states for the target non-serving cell, wherein the plurality of TCI state IDs is configured for use with the TCI codepoint in order to identify a TCI state pair from the activated TCI states for the handover.

The method 900 further includes communicating 910, with the UE on the target non-serving cell to implement the handover to the target non-serving cell.

In some embodiments of the method 900, the MAC-CE further comprises a cell ID for the target non-serving cell.

In some embodiments of the method 900, the MAC-CE further comprises an UL BWP ID and a DL BWP ID for the target non-serving cell.

In some embodiments of the method 900, the MAC-CE further comprises a bit indicating that the TCI codepoint is used to identify two of the plurality of TCI state IDs.

In some embodiments of the method 900, the MAC-CE further comprises a first value in a first 1-bit field indicating that a first TCI state of the TCI state pair is an UL TCI state and a second value in a second 1-bit field indicating that a second TCI state of the TCI state pair is a DL TCI state.

In some embodiments of the method 900, the MAC-CE further comprises a TA usage value in a TA usage field, the TA usage value indicating that a TA field in the MAC-CE is reserved and that the UE is to communicate with the target non-serving cell without using a TA offset value.

In some embodiments of the method 900, the MAC-CE further comprises a TA usage value in a TA usage field, the TA usage value indicating that a TA field in the MAC-CE is reserved and that the UE is to communicate with the target non-serving cell based on a currently configured TA offset value for the target non-serving cell.

In some embodiments of the method 900, the MAC-CE further comprises: a TA usage value in a TA usage field, the TA usage value indicating that the UE is to communicate with the target non-serving cell using a specified TA offset value, and the specified TA offset value in a TA field.

In some embodiments of the method 900, the MAC-CE further comprises: a TA usage value in a TA usage field, the TA usage value indicating that the UE is to perform a CFRA procedure with the target non-serving cell to determine a TA offset value to use to communicate with the target non-serving cell, and a TA field, comprising: a SSB index in a first set of bits of the TA field, the SSB index useable by the UE as part of the CFRA procedure to select a plurality of PRACH resources and a spatial relation for a PRACH transmission, and a PRACH index in a second set of bits of the TA field, the PRACH index useable by the UE as part of the CFRA procedure to select a PRACH resource from the plurality of PRACH resources.

In some embodiments of the method 900, the MAC-CE further comprises a timer value identifying a timer for use in determining whether the handover to the target non-serving cell has failed.

In some embodiments of the method 900, the MAC-CE further comprises an UL grant identifying resources useable by the UE for UL transmission on the target non-serving cell.

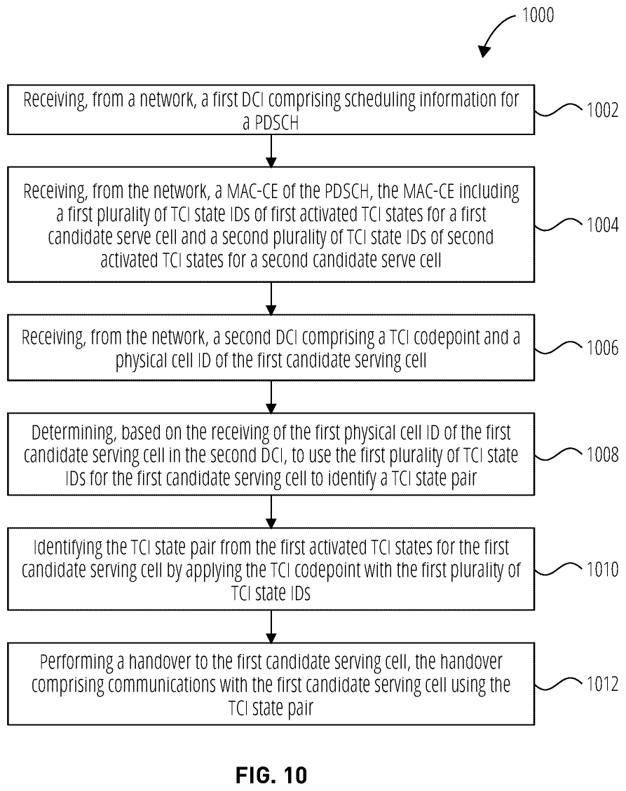

FIG. 10 illustrates a method 1000 of a UE, according to embodiments herein. The method 1000 includes receiving 1002, from a network, a first DCI comprising scheduling information for a PDSCH.

The method 1000 further includes receiving 1004, from the network, a MAC-CE of the PDSCH, the MAC-CE including a first plurality of TCI state IDs of first activated TCI states for a first candidate serves cell and a second plurality of TCI state IDs of second activated TCI states for a second candidate serves cell.

The method 1000 further includes receiving 1006, from the network, a second DCI comprising a TCI codepoint and a physical cell ID of the first candidate serving cell.

The method 1000 further includes determining 1008, based on the receiving of the first physical cell ID of the first candidate serving cell in the second DCI, to use the first plurality of TCI state IDs for the first candidate serving cell to identify a TCI state pair.

The method 1000 further includes identifying 1010 the TCI state pair from the first activated TCI states for the first candidate serving cell by applying the TCI codepoint with the first plurality of TCI state IDs.

The method 1000 further includes performing 1012 a handover to the first candidate serving cell, the handover comprising communications with the first candidate serving cell using the TCI state pair.

In some embodiments of the method 1000, the second DCI further comprises a TA offset value, and wherein the UE performs the handover to the first candidate serving cell using the TA offset value.

In some embodiments of the method 1000, the MAC-CE further comprises a cell ID for the first candidate serving cell.

In some embodiments of the method 1000, the MAC-CE further comprises an UL BWP ID and a DL BWP ID for the first candidate serving cell.

In some embodiments of the method 1000, the MAC-CE further comprises a bit indicating that the TCI codepoint is used to identify two of the first plurality of TCI state IDs.

In some embodiments of the method 1000, the MAC-CE further comprises a first value in a first 1-bit field indicating that a first TCI state of the TCI state pair is an UL TCI state and a second value in a second 1-bit field indicating that a second TCI state of the TCI state pair is a DL TCI state.

In some embodiments of the method 1000, the MAC-CE further comprises a TA usage field having a TA usage value indicating that a TA field in the MAC-CE is reserved and that the UE is to communicate with the first candidate serving cell without using a TA offset value, and wherein the UE performs UL transmission during the handover to the first candidate serving cell without using a TA offset value.

In some embodiments of the method 1000, the MAC-CE further comprises a TA usage field having a TA usage value indicating that a TA field in the MAC-CE is reserved and that the UE is to communicate with the first candidate serving cell based on a currently configured TA offset value for the first candidate serving cell, and wherein the UE performs UL transmission during the handover to the first candidate serving cell using the currently configured TA offset value for the first candidate serving cell.

In some embodiments of the method 1000, the MAC-CE further comprises: a TA usage field having a TA usage value indicating that the UE is to communicate with the first candidate serving cell using a specified TA offset value, and the specified TA offset value in a TA field, wherein the UE performs UL transmission during the handover to the first candidate serving cell using the specified TA offset value.

In some embodiments of the method 1000, the MAC-CE further comprises: a TA usage filed having a TA usage value indicating that the UE is to perform a CFRA procedure with the first candidate serving cell to determine a TA offset value to use to communicate with the first candidate serving cell, and a TA field comprising: a SSB index in a first set of bits of the TA field, the SSB index useable by the UE as part of the CFRA procedure to select a plurality of PRACH resources and a spatial relation for a PRACH transmission, and a PRACH index in a second set of bits of the TA field, the PRACH index useable by the UE as part of the CFRA procedure to select a PRACH resource from the plurality of PRACH resources, wherein the UE performs the handover to the first candidate serving cell using the TA offset value determined by performing the CFRA procedure.

In some embodiments of the method 1000, the MAC-CE further comprises a timer value identifying a timer for use in determining whether the handover to the first candidate serving cell has failed.

In some embodiments of the method 1000, the MAC-CE further comprises an UL grant identifying resources useable by the UE for UL transmission on the first candidate serving cell.

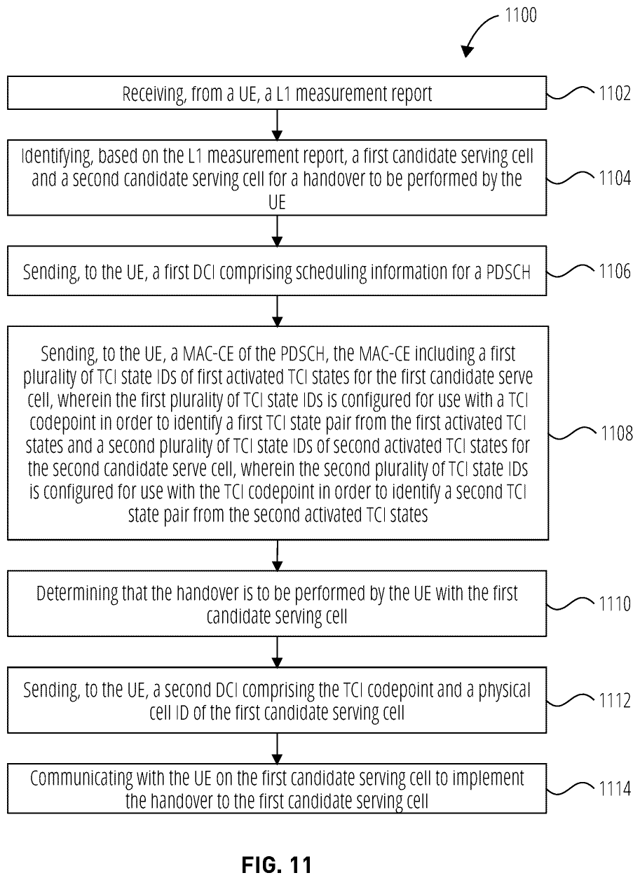

FIG. 11 illustrates a method 1100 of a RAN, according to embodiments herein. The method 1100 includes receiving 1102, from a UE, an L1 measurement report.

The method 1100 further includes identifying 1104, based on the L1 measurement report, a first candidate serving cell and a second candidate serving cell for a handover to be performed by the UE.

The method 1100 further includes sending 1106, to the UE, a first DCI comprising scheduling information for a PDSCH.

The method 1100 further includes sending 1108, to the UE, a MAC-CE of the PDSCH, the MAC-CE including a first plurality of TCI state IDs of first activated TCI states for the first candidate serves cell, wherein the first plurality of TCI state IDs is configured for use with a TCI codepoint in order to identify a first TCI state pair from the first activated TCI states and a second plurality of TCI state IDs of second activated TCI states for the second candidate serves cell, wherein the second plurality of TCI state IDs is configured for use with the TCI codepoint in order to identify a second TCI state pair from the second activated TCI states.

The method 1100 further includes determining 1110 that the handover is to be performed by the UE with the first candidate serving cell.

The method 1100 further includes sending 1112, to the UE, a second DCI comprising the TCI codepoint and a physical cell ID of the first candidate serving cell.

The method 1100 further includes communicating 1114 with the UE on the first candidate serving cell to implement the handover to the first candidate serving cell.

In some embodiments of the method 1100, the second DCI further comprises a TA offset value.

In some embodiments of the method 1100, the MAC-CE further comprises a cell ID for the first candidate serving cell.

In some embodiments of the method 1100, the MAC-CE further comprises an UL BWP ID and a DL BWP ID for the first candidate serving cell.

In some embodiments of the method 1100, the MAC-CE further comprises a bit indicating that the TCI codepoint is used to identify two of the first plurality of TCI state IDs.

In some embodiments of the method 1100, the MAC-CE further comprises a first value in a first 1-bit field indicating that a first TCI state of the TCI state pair is an UL TCI state and a second value in a second 1-bit field indicating that a second TCI state of the TCI state pair is a DL TCI state.

In some embodiments of the method 1100, the MAC-CE further comprises a TA usage field having a TA usage value indicating that a TA field in the MAC-CE is reserved and that the UE is to communicate with the first candidate serving cell without using a TA offset value.

In some embodiments of the method 1100, the MAC-CE further comprises a TA usage field having a TA usage value indicating that a TA field in the MAC-CE is reserved and that the UE is to communicate with the first candidate serving cell based on a currently configured TA offset value for the first candidate serving cell.

In some embodiments of the method 1100, the MAC-CE further comprises: a TA usage field having a TA usage value indicating that the UE is to communicate with the first candidate serving cell using a specified TA offset value, and the specified TA offset value in a TA field.

In some embodiments of the method 1100, the MAC-CE further comprises: a TA usage filed having a TA usage value indicating that the UE is to perform a CFRA procedure with the first candidate serving cell to determine a TA offset value to use to communicate with the first candidate serving cell, and a TA field comprising: a SSB index in a first set of bits of the TA field, the SSB index useable by the UE as part of the CFRA procedure to select a plurality of PRACH resources and a spatial relation for a PRACH transmission, and a PRACH index in a second set of bits of the TA field, the PRACH index useable by the UE as part of the CFRA procedure to select a PRACH resource from the plurality of PRACH resources.

In some embodiments of the method 1100, the MAC-CE further comprises a timer value identifying a timer for use in determining whether the handover to the first candidate serving cell has failed.

In some embodiments of the method 1100, the MAC-CE further comprises an UL grant identifying resources useable by the UE for UL transmission on the first candidate serving cell.

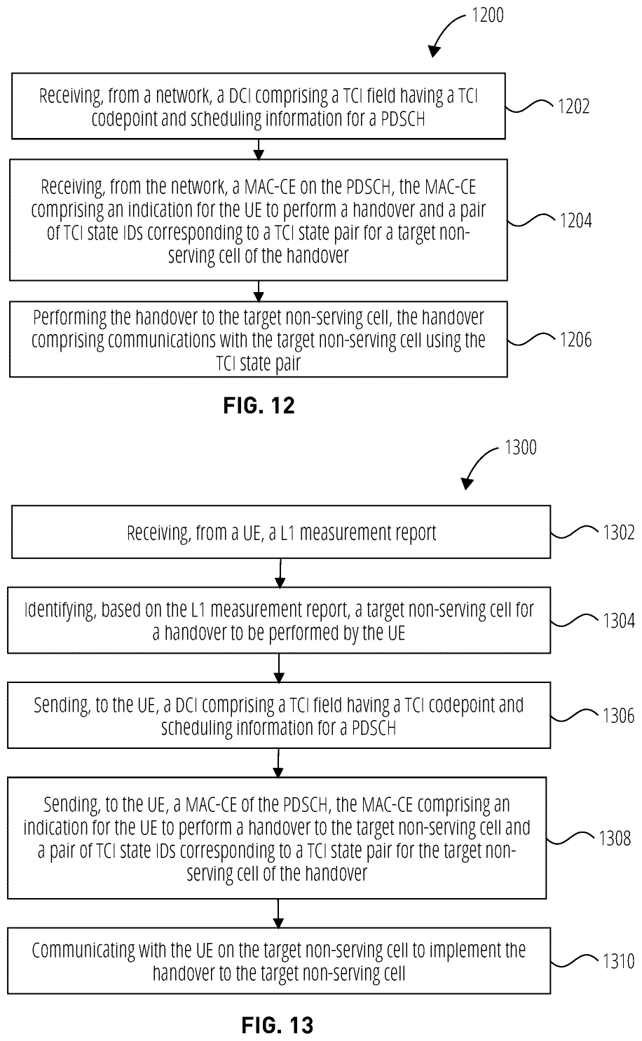

FIG. 12 illustrates a method 1200 of a UE, according to embodiments herein. The method 1200 includes receiving 1202, from a network, a DCI comprising a TCI field having a TCI codepoint and scheduling information for a PDSCH.

The method 1200 further includes receiving 1204, from the network, a MAC-CE on the PDSCH, the MAC-CE comprising an indication for the UE to perform a handover and a pair of TCI state IDs corresponding to a TCI state pair for a target non-serving cell of the handover.

The method 1200 further includes performing 1206 the handover to the target non-serving cell, the handover comprising communications with the target non-serving cell using the TCI state pair.

FIG. 13 illustrates a method 1300 of a RAN, according to embodiments herein. The method 1300 includes receiving 1302, from a UE, a L1 measurement report.

The method 1300 further includes identifying 1304, based on the L1 measurement report, a target non-serving cell for a handover to be performed by the UE.

The method 1300 further includes sending 1306, to the UE, a DCI comprising a TCI field having a TCI codepoint and scheduling information for a PDSCH.

The method 1300 further includes sending 1308, to the UE, a MAC-CE of the PDSCH, the MAC-CE comprising an indication for the UE to perform a handover to the target non-serving cell and a pair of TCI state IDs corresponding to a TCI state pair for the target non-serving cell of the handover.

The method 1300 further includes communicating 1310, with the UE on the target non-serving cell to implement the handover to the target non-serving cell.

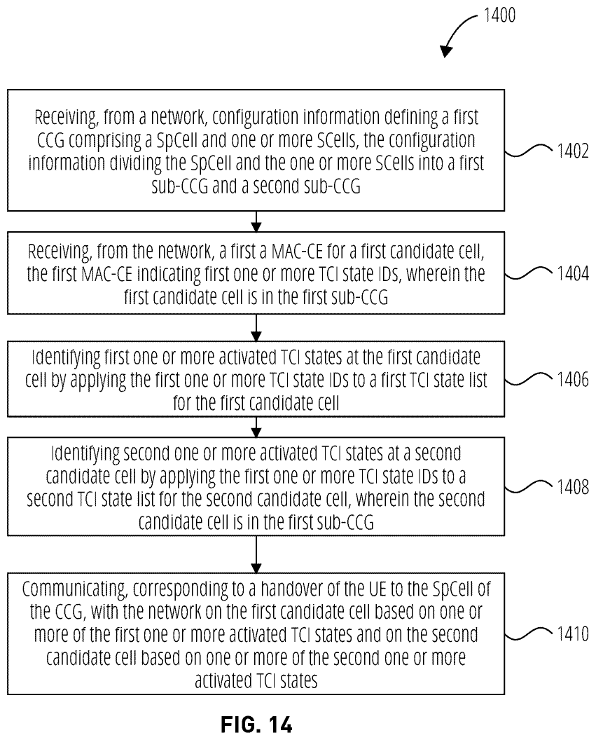

FIG. 14 illustrates a method 1400 of a UE, according to embodiments herein. The method 1400 includes receiving 1402, from a network, configuration information defining a first CCG comprising a SpCell and one or more SCells, the configuration information dividing the SpCell and the one or more SCells into a first sub-CCG and a second sub-CCG.

The method 1400 further includes receiving 1404, from the network, a first a MAC-CE for a first candidate cell, the first MAC-CE indicating first one or more TCI state IDs, wherein the first candidate cell is in the first sub-CCG.

The method 1400 further includes identifying 1406, first one or more activated TCI states at the first candidate cell by applying the first one or more TCI state IDs to a first TCI state list for the first candidate cell.

The method 1400 further includes identifying 1408, second one or more activated TCI states at a second candidate cell by applying the first one or more TCI state IDs to a second TCI state list for the second candidate cell, wherein the second candidate cell is in the first sub-CCG.

The method 1400 further includes communicating 1410, corresponding to a handover of the UE to the SpCell of the CCG, with the network on the first candidate cell based on one or more of the first one or more activated TCI states and on the second candidate cell based on one or more of the second one or more activated TCI states.

In some embodiments, the method 1400 further comprises: receiving, from the network, a second MAC-CE for a third candidate cell, the second MAC-CE indicating second one or more TCI state IDs, wherein the third candidate cell is in the second sub-CCG, identifying third one or more activated TCI states at the third candidate cell by applying the second one or more TCI state IDs to a third TCI state list for the third candidate cell, and communicating, corresponding to the handover of the UE to the SpCell of the CCG, with the network on the third candidate cell based on one or more of the third one or more activated TCI states. Some such embodiments further comprise: identifying fourth one or more activated TCI states at a fourth candidate cell by applying the second one or more TCI state IDs to a fourth TCI state list for the fourth candidate cell, wherein the fourth candidate cell is on the second sub-CCG; and communicating, corresponding to the handover of the UE to the SpCell of the CCG, with the network on the fourth candidate cell based on one or more of the fourth one or more activated TCI states.

In some embodiments of the method 1400, the first sub-CCG comprises the SpCell.

In some embodiments of the method 1400, the second sub-CCG comprises the SpCell.

In some embodiments, the method 1400 further comprises receiving, from the network, the first TCI state list for the first candidate cell in an RRC message.

In some embodiments of the method 1400, the configuration information defining the CCG is received in an RRC message.

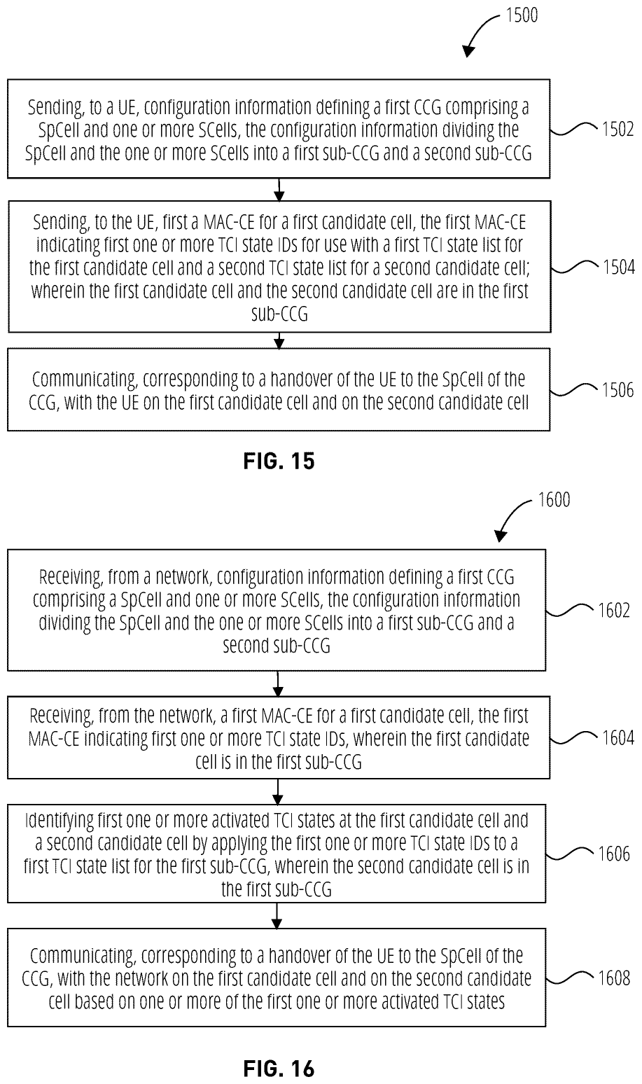

FIG. 15 illustrates a method 1500 of a RAN, according to embodiments herein. The method 1500 includes sending 1502, to a UE, configuration information defining a first CCG comprising a SpCell and one or more SCells, the configuration information dividing the SpCell and the one or more SCells into a first sub-CCG and a second sub-CCG.

The method 1500 further includes sending 1504, to the UE, first a MAC-CE for a first candidate cell, the first MAC-CE indicating first one or more TCI state IDs for use with a first TCI state list for the first candidate cell and a second TCI state list for a second candidate cell; wherein the first candidate cell and the second candidate cell are in the first sub-CCG.

The method 1500 further includes communicating 1506, corresponding to a handover of the UE to the SpCell of the CCG, with the UE on the first candidate cell and on the second candidate cell.

In some embodiments, the method 1500 further comprises: sending, to the UE, a second MAC-CE for a third candidate cell, the second MAC-CE indicating second one or more TCI state IDs for use with a third TCI state list for the third candidate cell, wherein the third candidate cell is in the second sub-CCG, and communicating, corresponding to the handover of the UE to the SpCell of the CCG, with the UE on the third candidate cell. In some such embodiments, the second one or more TCI state IDs is further for use with a fourth TCI state list for a fourth candidate cell, wherein the fourth candidate cell is in the second sub-CCG, and further comprising communicating, corresponding to the handover of the UE to the SpCell of the CCG, with the UE on the fourth candidate cell.

In some embodiments of the method 1500, the first sub-CCG comprises the SpCell.

In some embodiments of the method 1500, the second sub-CCG comprises the SpCell.

In some embodiments, the method 1500 further comprises sending, to the UE, the first TCI state list for the first candidate cell in an RRC message.

In some embodiments of the method 1500, the configuration information defining the CCG is sent in an RRC message.

FIG. 16 illustrates a method 1600 of a UE, according to embodiments herein. The method 1600 includes receiving 1602, from a network, configuration information defining a first CCG comprising a SpCell and one or more SCells, the configuration information dividing the SpCell and the one or more SCells into a first sub-CCG and a second sub-CCG.

The method 1600 further includes receiving 1604, from the network, a first MAC-CE for a first candidate cell, the first MAC-CE indicating first one or more TCI state IDs, wherein the first candidate cell is in the first sub-CCG.

The method 1600 further includes identifying 1606, first one or more activated TCI states at the first candidate cell and a second candidate cell by applying the first one or more TCI state IDs to a first TCI state list for the first sub-CCG, wherein the second candidate cell is in the first sub-CCG.

The method 1600 further includes communicating 1608, corresponding to a handover of the UE to the SpCell of the CCG, with the network on the first candidate cell and on the second candidate cell based on one or more of the first one or more activated TCI states.

In some embodiments, the method 1600 further comprises: receiving, from the network, a second MAC-CE for a third candidate cell, the second MAC-CE indicating second one or more TCI state IDs, wherein the third candidate cell is in the second sub-CCG; identifying second one or more activated TCI states at the third candidate cell and a fourth candidate cell by applying the second one or more TCI state IDs to a second TCI state list for the second sub-CCG, wherein the fourth candidate cell is in the second sub-CCG; and communicating, corresponding to the handover of the UE to the SpCell of the CCG, with the network on the third candidate cell and on the fourth candidate cell based on one or more of the second one or more activated TCI states.

In some embodiments of the method 1600, the first sub-CCG comprises the SpCell.

In some embodiments of the method 1600, the second sub-CCG comprises the SpCell.

In some embodiments, the method 1600 further comprises receiving, from the network, the first TCI state list for the first sub-CCG in an RRC message.

In some embodiments of the method 1600, the configuration information defining the CCG is received in an RRC message.

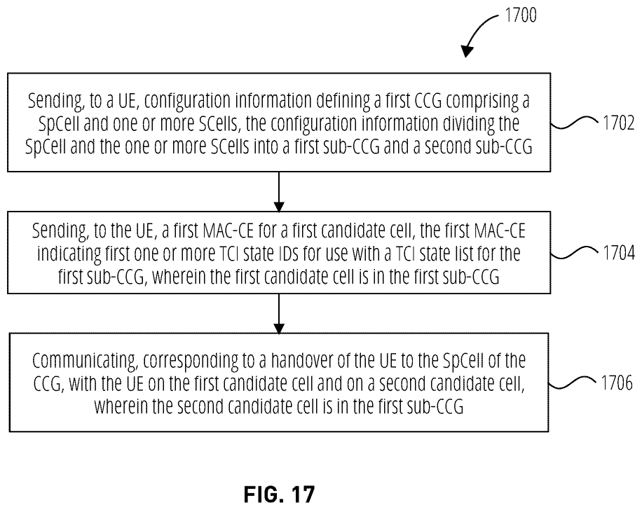

FIG. 17 illustrates a method 1700 of a RAN, according to embodiments herein. The method 1700 includes sending 1702, to a UE, configuration information defining a first CCG comprising a SpCell and one or more SCells, the configuration information dividing the SpCell and the one or more SCells into a first sub-CCG and a second sub-CCG.

The method 1700 further includes sending 1704, to the UE, a first MAC-CE for a first candidate cell, the first MAC-CE indicating first one or more TCI state IDs for use with a TCI state list for the first sub-CCG, wherein the first candidate cell is in the first sub-CCG.

The method 1700 further includes communicating 1706, corresponding to a handover of the UE to the SpCell of the CCG, with the UE on the first candidate cell and on a second candidate cell, wherein the second candidate cell is in the first sub-CCG.

In some embodiments, the method 1700 further comprises: receiving, from the network, a second MAC-CE for a third candidate cell, the second MAC-CE indicating second one or more TCI state IDs for use with a TCI state list for the second sub-CCG, wherein the third candidate cell is in the second sub-CCG, and communicating, corresponding to the handover of the UE to the SpCell of the CCG, with the network on the third candidate cell and on a fourth candidate cell, wherein the fourth candidate cell is in the second sub-CCG.

In some embodiments of the method 1700, the first sub-CCG comprises the SpCell.

In some embodiments of the method 1700, the second sub-CCG comprises the SpCell.

In some embodiments, the method 1700 further comprises sending, to the UE, the first TCI state list for the first sub-CCG in an RRC message.

In some embodiments of the method 1700, the configuration information defining the CCG is sent in an RRC message.

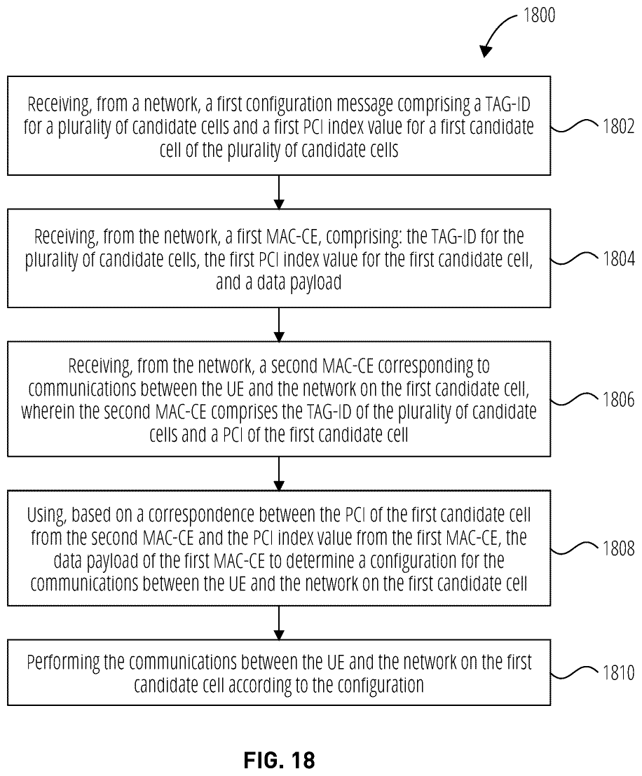

FIG. 18 illustrates a method 1800 of a UE, according to embodiments herein. The method 1800 includes receiving 1802, from a network, a first configuration message comprising a TAG-ID for a plurality of candidate cells and a first PCI index value for a first candidate cell of the plurality of candidate cells.

The method 1800 further includes receiving 1804, from the network, a first MAC-CE, comprising: the TAG-ID for the plurality of candidate cells, the first PCI index value for the first candidate cell, and a data payload.

The method 1800 further includes receiving 1806, from the network, a second MAC-CE corresponding to communications between the UE and the network on the first candidate cell, wherein the second MAC-CE comprises the TAG-ID of the plurality of candidate cells and a PCI of the first candidate cell.

The method 1800 further includes using 1808, based on a correspondence between the PCI of the first candidate cell from the second MAC-CE and the PCI index value from the first MAC-CE, the data payload of the first MAC-CE to determine a configuration for the communications between the UE and the network on the first candidate cell.

The method 1800 further includes performing 1810 the communications between the UE and the network on the first candidate cell according to the configuration.

In some embodiments of the method 1800: the data payload comprises a TAC for the first candidate cell, the communications between the UE and the first candidate cell comprises a handover of the UE to the first candidate cell, and the value indicated by the TAC is used for UL transmission between the UE and the first candidate cell corresponding to the handover of the UE to the first candidate cell. Some such embodiments further comprise, storing an association between the TAC for the first candidate cell, the PCI index value for the first candidate cell, and the PCI of the first candidate cell at the UE. Some such embodiments further comprise, receiving, from the network, an indication of the correspondence between the PCI for the first candidate cell and the PCI index value. In some such embodiments, the TAC comprises a TA offset value. In some such embodiments, the TAC comprises a TA offset adjustment value. In some such embodiments, the first MAC-CE is a RAR MAC-CE. In some such embodiments, the first MAC-CE is a TAC MAC-CE.

In some embodiments of the method 1800, the first configuration message further comprises a second PCI index value for a second candidate cell of the plurality of candidate cells.

In some embodiments, the method 1800 further comprises receiving, from the network, a second configuration message comprising a second PCI index value for a second candidate cell of the plurality of candidate cells.

In some embodiments, the method 1800 further comprises receiving, from the network, a second configuration message comprising a replacement PCI index value for the first candidate cell of the plurality of candidate cells.

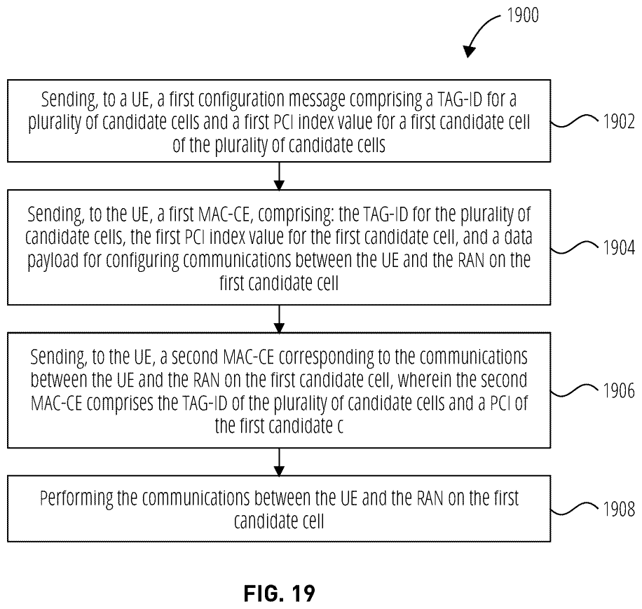

FIG. 19 illustrates a method 1900 of a RAN, according to embodiments herein. The method 1900 includes sending 1902, to a UE, a first configuration message comprising a TAG-ID for a plurality of candidate cells and a first PCI index value for a first candidate cell of the plurality of candidate cells.

The method 1900 further includes sending 1904, to the UE, a first MAC-CE, comprising: the TAG-ID for the plurality of candidate cells, the first PCI index value for the first candidate cell, and a data payload for configuring communications between the UE and the RAN on the first candidate cell.

The method 1900 further includes sending 1906, to the UE, a second MAC-CE corresponding to the communications between the UE and the RAN on the first candidate cell, wherein the second MAC-CE comprises the TAG-ID of the plurality of candidate cells and a PCI of the first candidate cell.

The method 1900 further includes performing 1908 the communications between the UE and the RAN on the first candidate cell.

In some embodiments of the method 1900: the data payload comprises a TAC for the first candidate cell, and the communications between the UE and the first candidate cell comprises a handover of the UE to the first candidate cell. In some such embodiments, the TAC comprises a TA offset value. In some such embodiments, the TAC comprises a TA offset adjustment value. In some such embodiments, the first MAC-CE is a RAR MAC-CE. In some such embodiments, the first MAC-CE is a TAC MAC-CE.

In some embodiments of the method 1900, the first configuration message further comprises a second PCI index value for a second candidate cell of the plurality of candidate cells.

In some embodiments, the method 1900 further comprises sending, to the UE, a second configuration message comprising a second PCI index value for a second candidate cell of the plurality of candidate cells.

In some embodiments, the method 1900 further comprises sending, to the UE, a second configuration message comprising a replacement PCI index value for the first candidate cell of the plurality of candidate cells.

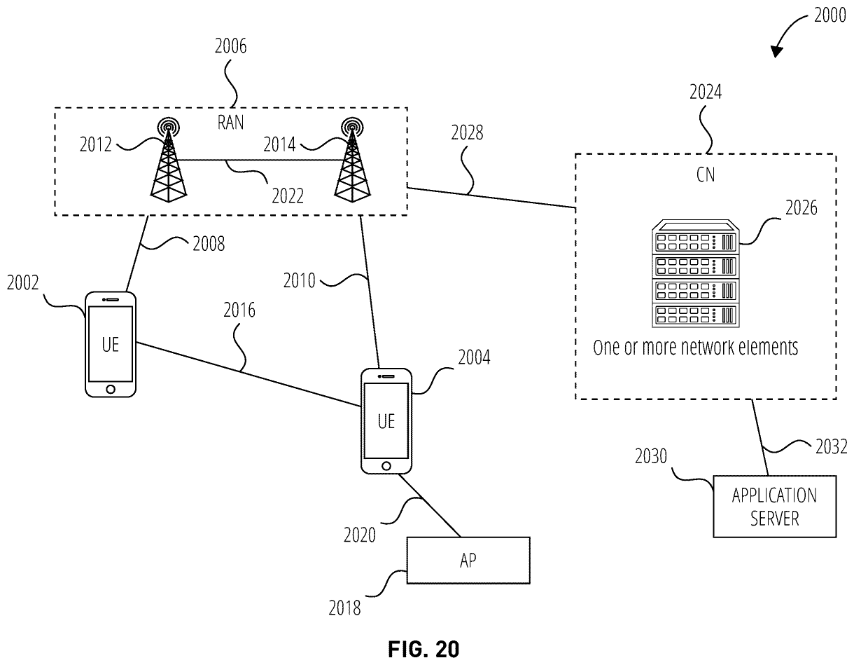

FIG. 20 illustrates an example architecture of a wireless communication system 2000, according to embodiments disclosed herein. The following description is provided for an example wireless communication system 2000 that operates in conjunction with the LTE system standards and/or 5G or NR system standards as provided by 3GPP technical specifications.

As shown by FIG. 20, the wireless communication system 2000 includes UE 2002 and UE 2004 (although any number of UEs may be used). In this example, the UE 2002 and the UE 2004 are illustrated as smartphones (e.g., handheld touchscreen mobile computing devices connectable to one or more cellular networks), but may also comprise any mobile or non-mobile computing device configured for wireless communication.

The UE 2002 and UE 2004 may be configured to communicatively couple with a RAN 2006. In embodiments, the RAN 2006 may be NG-RAN, E-UTRAN, etc. The UE 2002 and UE 2004 utilize connections (or channels) (shown as connection 2008 and connection 2010, respectively) with the RAN 2006, each of which comprises a physical communications interface. The RAN 2006 can include one or more base stations (such as base station 2012 and base station 2014) that enable the connection 2008 and connection 2010.

In this example, the connection 2008 and connection 2010 are air interfaces to enable such communicative coupling, and may be consistent with RAT(s) used by the RAN 2006, such as, for example, an LTE and/or NR.

In some embodiments, the UE 2002 and UE 2004 may also directly exchange communication data via a sidelink interface 2016. The UE 2004 is shown to be configured to access an access point (shown as AP 2018) via connection 2020. By way of example, the connection 2020 can comprise a local wireless connection, such as a connection consistent with any IEEE 802.11 protocol, wherein the AP 2018 may comprise a Wi-Fi® router. In this example, the AP 2018 may be connected to another network (for example, the Internet) without going through a CN 2024.

In embodiments, the UE 2002 and UE 2004 can be configured to communicate using orthogonal frequency division multiplexing (OFDM) communication signals with each other or with the base station 2012 and/or the base station 2014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 2012 or base station 2014 may be implemented as one or more software entities running on server computers as part of a virtual network. In addition, or in other embodiments, the base station 2012 or base station 2014 may be configured to communicate with one another via interface 2022. In embodiments where the wireless communication system 2000 is an LTE system (e.g., when the CN 2024 is an EPC), the interface 2022 may be an X2 interface. The X2 interface may be defined between two or more base stations (e.g., two or more eNBs and the like) that connect to an EPC, and/or between two eNBs connecting to the EPC. In embodiments where the wireless communication system 2000 is an NR system (e.g., when CN 2024 is a 5GC), the interface 2022 may be an Xn interface. The Xn interface is defined between two or more base stations (e.g., two or more gNBs and the like) that connect to 5GC, between a base station 2012 (e.g., a gNB) connecting to 5GC and an eNB, and/or between two eNBs connecting to 5GC (e.g., CN 2024).

The RAN 2006 is shown to be communicatively coupled to the CN 2024. The CN 2024 may comprise one or more network elements 2026, which are configured to offer various data and telecommunications services to customers/subscribers (e.g., users of UE 2002 and UE 2004) who are connected to the CN 2024 via the RAN 2006. The components of the CN 2024 may be implemented in one physical device or separate physical devices including components to read and execute instructions from a machine-readable or computer-readable medium (e.g., a non-transitory machine-readable storage medium).

In embodiments, the CN 2024 may be an EPC, and the RAN 2006 may be connected with the CN 2024 via an S1 interface 2028. In embodiments, the S1 interface 2028 may be split into two parts, an S1 user plane (S1-U) interface, which carries traffic data between the base station 2012 or base station 2014 and a serving gateway (S-GW), and the S1-MME interface, which is a signaling interface between the base station 2012 or base station 2014 and mobility management entities (MMEs).

In embodiments, the CN 2024 may be a 5GC, and the RAN 2006 may be connected with the CN 2024 via an NG interface 2028. In embodiments, the NG interface 2028 may be split into two parts, an NG user plane (NG-U) interface, which carries traffic data between the base station 2012 or base station 2014 and a user plane function (UPF), and the S1 control plane (NG-C) interface, which is a signaling interface between the base station 2012 or base station 2014 and access and mobility management functions (AMFs).

Generally, an application server 2030 may be an element offering applications that use internet protocol (IP) bearer resources with the CN 2024 (e.g., packet switched data services). The application server 2030 can also be configured to support one or more communication services (e.g., VOIP sessions, group communication sessions, etc.) for the UE 2002 and UE 2004 via the CN 2024. The application server 2030 may communicate with the CN 2024 through an IP communications interface 2032.

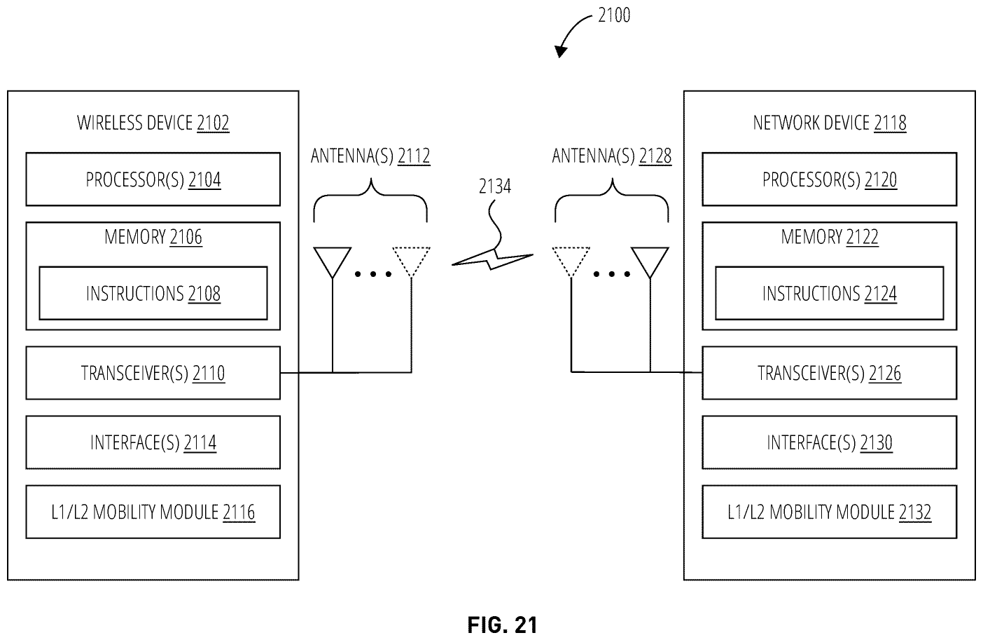

FIG. 21 illustrates a system 2100 for performing signaling 2134 between a wireless device 2102 and a network device 2118, according to embodiments disclosed herein. The system 2100 may be a portion of a wireless communications system as herein described. The wireless device 2102 may be, for example, a UE of a wireless communication system. The network device 2118 may be, for example, a base station (e.g., an eNB or a gNB) of a wireless communication system.

The wireless device 2102 may include one or more processor(s) 2104. The processor(s) 2104 may execute instructions such that various operations of the wireless device 2102 are performed, as described herein. The processor(s) 2104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 2102 may include a memory 2106. The memory 2106 may be a non-transitory computer-readable storage medium that stores instructions 2108 (which may include, for example, the instructions being executed by the processor(s) 2104). The instructions 2108 may also be referred to as program code or a computer program. The memory 2106 may also store data used by, and results computed by, the processor(s) 2104.

The wireless device 2102 may include one or more transceiver(s) 2110 that may include radio frequency (RF) transmitter and/or receiver circuitry that use the antenna(s) 2112 of the wireless device 2102 to facilitate signaling (e.g., the signaling 2134) to and/or from the wireless device 2102 with other devices (e.g., the network device 2118) according to corresponding RATs.

The wireless device 2102 may include one or more antenna(s) 2112 (e.g., one, two, four, or more). For embodiments with multiple antenna(s) 2112, the wireless device 2102 may leverage the spatial diversity of such multiple antenna(s) 2112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 2102 may be accomplished according to precoding (or digital beamforming) that is applied at the wireless device 2102 that multiplexes the data streams across the antenna(s) 2112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 2102 may implement analog beamforming techniques, whereby phases of the signals sent by the antenna(s) 2112 are relatively adjusted such that the (joint) transmission of the antenna(s) 2112 can be directed (this is sometimes referred to as beam steering).

The wireless device 2102 may include one or more interface(s) 2114. The interface(s) 2114 may be used to provide input to or output from the wireless device 2102. For example, a wireless device 2102 that is a UE may include interface(s) 2114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 2110/antenna(s) 2112 already described) that allow for communication between the UE and other devices and may operate according to known protocols (e.g., Wi-Fi®, Bluetooth®, and the like).

The wireless device 2102 may include an L1/L2 mobility module 2116. The L1/L2 mobility module 2116 may be implemented via hardware, software, or combinations thereof. For example, the L1/L2 mobility module 2116 may be implemented as a processor, circuit, and/or instructions 2108 stored in the memory 2106 and executed by the processor(s) 2104. In some examples, the L1/L2 mobility module 2116 may be integrated within the processor(s) 2104 and/or the transceiver(s) 2110. For example, the L1/L2 mobility module 2116 may be implemented by a combination of software components (e.g., executed by a DSP or a general processor) and hardware components (e.g., logic gates and circuitry) within the processor(s) 2104 or the transceiver(s) 2110.

The L1/L2 mobility module 2116 may be used for various aspects of the present disclosure, for example, aspects of FIG. 1 through FIG. 19. The L1/L2 mobility module 2116 is configured to receive a cell switching command as a combination of a DC and a MAC-CE and perform a corresponding handover; to receive TCI state IDs and apply them with respect to all candidate cells of a sub-CCG in a configured CCG; and/or to receive and use information (including TA information) from the network by via TAG-specific PCI indexes for a group of candidate cells in a TAG, in the manner described herein.

The network device 2118 may include one or more processor(s) 2120. The processor(s) 2120 may execute instructions such that various operations of the network device 2118 are performed, as described herein. The processor(s) 2120 may include one or more baseband processors implemented using, for example, a CPU, a DSP, an ASIC, a controller, an FPGA device, another hardware device, a firmware device, or any combination thereof configured to perform the operations described herein.

The network device 2118 may include a memory 2122. The memory 2122 may be a non-transitory computer-readable storage medium that stores instructions 2124 (which may include, for example, the instructions being executed by the processor(s) 2120). The instructions 2124 may also be referred to as program code or a computer program. The memory 2122 may also store data used by, and results computed by, the processor(s) 2120.

The network device 2118 may include one or more transceiver(s) 2126 that may include RF transmitter and/or receiver circuitry that use the antenna(s) 2128 of the network device 2118 to facilitate signaling (e.g., the signaling 2134) to and/or from the network device 2118 with other devices (e.g., the wireless device 2102) according to corresponding RATs.

The network device 2118 may include one or more antenna(s) 2128 (e.g., one, two, four, or more). In embodiments having multiple antenna(s) 2128, the network device 2118 may perform MIMO, digital beamforming, analog beamforming, beam steering, etc., as has been described.

The network device 2118 may include one or more interface(s) 2130. The interface(s) 2130 may be used to provide input to or output from the network device 2118. For example, a network device 2118 that is a base station may include interface(s) 2130 made up of transmitters, receivers, and other circuitry (e.g., other than the transceiver(s) 2126/antenna(s) 2128 already described) that enables the base station to communicate with other equipment in a core network, and/or that enables the base station to communicate with external networks, computers, databases, and the like for purposes of operations, administration, and maintenance of the base station or other equipment operably connected thereto.

The network device 2118 may include an L1/L2 mobility module 2132. The L1/L2 mobility module 2132 may be implemented via hardware, software, or combinations thereof. For example, the L1/L2 mobility module 2132 may be implemented as a processor, circuit, and/or instructions 2124 stored in the memory 2122 and executed by the processor(s) 2120. In some examples, the L1/L2 mobility module 2132 may be integrated within the processor(s) 2120 and/or the transceiver(s) 2126. For example, the L1/L2 mobility module 2132 may be implemented by a combination of software components (e.g., executed by a DSP or a general processor) and hardware components (e.g., logic gates and circuitry) within the processor(s) 2120 or the transceiver(s) 2126.

The L1/L2 mobility module 2132 may be used for various aspects of the present disclosure, for example, aspects of FIG. 1 through FIG. 19. The L1/L2 mobility module 2132 is configured to cause the network device 2118 to transmit a cell switching command as a combination of a DC and a MAC-CE; to configure sub-CCGs and transmit TCI state IDs for use with respect to all candidate cells of a sub-CCG; and/or to configure and communicate information (including TA information) to a UE using TAG-specific PCI indexes for a group of candidate cells in a TAG, in the manner described herein.

Embodiments contemplated herein include an apparatus comprising means to perform one or more elements of any of the method 800, the method 1000, the method 1200, the method 1400, the method 1600, and the method 1800. This apparatus may be, for example, an apparatus of a UE (such as a wireless device 2102 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 800, the method 1000, the method 1200, the method 1400, the method 1600, and the method 1800. This non-transitory computer-readable media may be, for example, a memory of a UE (such as a memory 2106 of a wireless device 2102 that is a UE, as described herein).

Embodiments contemplated herein include an apparatus comprising logic, modules, or circuitry to perform one or more elements of any of the method 800, the method 1000, the method 1200, the method 1400, the method 1600, and the method 1800. This apparatus may be, for example, an apparatus of a UE (such as a wireless device 2102 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 800, the method 1000, the method 1200, the method 1400, the method 1600, and the method 1800. This apparatus may be, for example, an apparatus of a UE (such as a wireless device 2102 that is a UE, as described herein).

Embodiments contemplated herein include a signal as described in or related to one or more elements of any of the method 800, the method 1000, the method 1200, the method 1400, the method 1600, and the method 1800.

Embodiments contemplated herein include a computer program or computer program product comprising instructions, wherein execution of the program by a processor is to cause the processor to carry out one or more elements of any of the method 800, the method 1000, the method 1200, the method 1400, the method 1600, and the method 1800. The processor may be a processor of a UE (such as a processor(s) 2104 of a wireless device 2102 that is a UE, as described herein). These instructions may be, for example, located in the processor and/or on a memory of the UE (such as a memory 2106 of a wireless device 2102 that is a UE, as described herein).

Embodiments contemplated herein include an apparatus comprising means to perform one or more elements of any of the method 900, the method 1100, the method 1300, the method 1500, the method 1700, and the method 1900. This apparatus may be, for example, an apparatus of a base station (such as a network device 2118 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 900, the method 1100, the method 1300, the method 1500, the method 1700, and the method 1900. This non-transitory computer-readable media may be, for example, a memory of a base station (such as a memory 2122 of a network device 2118 that is a base station, as described herein).

Embodiments contemplated herein include an apparatus comprising logic, modules, or circuitry to perform one or more elements of any of the method 900, the method 1100, the method 1300, the method 1500, the method 1700, and the method 1900. This apparatus may be, for example, an apparatus of a base station (such as a network device 2118 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 900, the method 1100, the method 1300, the method 1500, the method 1700, and the method 1900. This apparatus may be, for example, an apparatus of a base station (such as a network device 2118 that is a base station, as described herein).

Embodiments contemplated herein include a signal as described in or related to one or more elements of any of the method 900, the method 1100, the method 1300, the method 1500, the method 1700, and the method 1900.

Embodiments contemplated herein include a computer program or computer program product comprising instructions, wherein execution of the program by a processing element is to cause the processing element to carry out one or more elements of any of the method 900, the method 1100, the method 1300, the method 1500, the method 1700, and the method 1900. The processor may be a processor of a base station (such as a processor(s) 2120 of a network device 2118 that is a base station, as described herein). These instructions may be, for example, located in the processor and/or on a memory of the base station (such as a memory 2122 of a network device 2118 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a network, a downlink control information (DCI) comprising a transmission configuration indicator (TCI) field having a TCI codepoint and scheduling information for a physical downlink shared channel (PDSCH):
receiving, from the network, a medium access control control element (MAC-CE) of the PDSCH, the MAC-CE comprising an indication for the UE to perform a handover and a plurality TCI state identifiers (IDs) of activated TCI states for a target non-serving cell of the handover:
identifying a TCI state pair from the activated TCI states by applying the TCI codepoint with the plurality of TCI state IDs: and
performing the handover to the target non-serving cell, the handover comprising communications with the target non-serving cell using the TCI state pair.

2. The method of claim 1, wherein the MAC-CE further comprises a cell identifier (ID) for the target non-serving cell.

3. The method of claim 1, wherein the MAC-CE further comprises an uplink (UL) bandwidth part (BWP) identifier (ID) and a downlink (DL) BWP ID for the target non-serving cell.

4. The method of claim 1, wherein the MAC-CE further comprises a bit indicating that the TCI codepoint is used to identify two of the plurality of TCI state IDs.

5. The method of claim 1, wherein the MAC-CE further comprises a first value in a first 1-bit field indicating that a first TCI state of the TCI state pair is an uplink (UL) TCI state and a second value in a second 1-bit field indicating that a second TCI state of the TCI state pair is a downlink (DL) TCI state.

6. The method of claim 1, wherein the MAC-CE further comprises a timing advance (TA) usage value in a TA usage field, the TA usage value indicating that a TA field in the MAC-CE is reserved and that the UE is to communicate with the target non-serving cell without using a TA offset value, and wherein the UE performs uplink (UL) transmission during the handover to the target non-serving cell without using a TA offset value.

7. The method of claim 1, wherein the MAC-CE further comprises a timing advance (TA) usage value in a TA usage field, the TA usage value indicating that a TA field in the MAC-CE is reserved and that the UE is to communicate with the target non-serving cell based on a currently configured TA offset value for the target non-serving cell, and wherein the UE performs uplink (UL) transmission during the handover to the target non-serving cell using the currently configured TA offset value for the target non-serving cell.

8. The method of claim 1, wherein the MAC-CE further comprises:
a timing advance (TA) usage value in a TA usage field, the TA usage value indicating that the UE is to communicate with the target non-serving cell using a specified TA offset value: and
the specified TA offset value in a TA field;
wherein the UE performs uplink (UL) transmission during the handover to the target non-serving cell using the specified TA offset value.

9. The method of claim 1, wherein the MAC-CE further comprises:
a timing advance (TA) usage value in a TA usage field, the TA usage value indicating that the UE is to perform a contention free random access (CFRA) procedure with the target non-serving cell to determine a TA offset value to use to communicate with the target non-serving cell: and
a TA field, comprising:
a synchronization signal block (SSB) index in a first set of bits of the TA field, the SSB index useable by the UE as part of the CFRA procedure to select a plurality of physical random access channel (PRACH) resources and a spatial relation for a PRACH transmission: and
a PRACH index in a second set of bits of the TA field, the PRACH index useable by the UE as part of the CFRA procedure to select a PRACH resource from the plurality of PRACH resources;
wherein the UE performs the handover to the target non-serving cell using the TA offset value determined by performing the CFRA procedure.

10. The method of claim 1, wherein the MAC-CE further comprises a timer value identifying a timer for use in determining whether the handover to the target non-serving cell has failed.

11. The method of claim 1, wherein the MAC-CE further comprises an uplink (UL) grant identifying resources useable by the UE for UL transmission on the target non-serving cell.

12. A method of a radio access network (RAN), comprising:
receiving, from a user equipment (UE), a layer 1 (L1) measurement report:
identifying, based on the L1 measurement report, a target non-serving cell for a handover to be performed by the UE:
sending, to the UE, a downlink control information (DCI) comprising a transmission configuration indicator (TCI) field having a TCI codepoint and scheduling information for a physical downlink shared channel (PDSCH):
sending, to the UE, a medium access control control element (MAC-CE) on the PDSCH, the MAC-CE comprising an indication for the UE to perform a handover and a plurality TCI state identifiers (IDs) of activated TCI states for the target non-serving cell, wherein the plurality of TCI state IDs is configured for use with the TCI codepoint in order to identify a TCI state pair from the activated TCI states for the handover: and
communicating with the UE on the target non-serving cell to implement the handover to the target non-serving cell.

13. The method of claim 12, wherein the MAC-CE further comprises a cell identifier (ID) for the target non-serving cell.

14. The method of claim 12, wherein the MAC-CE further comprises an uplink (UL) bandwidth part (BWP) identifier (ID) and a downlink (DL) BWP ID for the target non-serving cell.

15. The method of claim 12, wherein the MAC-CE further comprises a bit indicating that the TCI codepoint is used to identify two of the plurality of TCI state IDs.

16. The method of claim 12, wherein the MAC-CE further comprises a first value in a first 1-bit field indicating that a first TCI state of the TCI state pair is an uplink (UL) TCI state and a second value in a second 1-bit field indicating that a second TCI state of the TCI state pair is a downlink (DL) TCI state.

17. The method of claim 12, wherein the MAC-CE further comprises a timing advance (TA) usage value in a TA usage field, the TA usage value indicating that a TA field in the MAC-CE is reserved and that the UE is to communicate with the target non-serving cell without using a TA offset value.

18. The method of claim 12, wherein the MAC-CE further comprises a timing advance (TA) usage value in a TA usage field, the TA usage value indicating that a TA field in the MAC-CE is reserved and that the UE is to communicate with the target non-serving cell based on a currently configured TA offset value for the target non-serving cell.

19. The method of claim 12, wherein the MAC-CE further comprises:
a timing advance (TA) usage value in a TA usage field, the TA usage value indicating that the UE is to communicate with the target non-serving cell using a specified TA offset value; and
the specified TA offset value in a TA field.

20. The method of claim 12, wherein the MAC-CE further comprises:
a timing advance (TA) usage value in a TA usage field, the TA usage value indicating that the UE is to perform a contention free random access (CFRA) procedure with the target non-serving cell to determine a TA offset value to use to communicate with the target non-serving cell; and
a TA field, comprising:
a synchronization signal block (SSB) index in a first set of bits of the TA field, the SSB index useable by the UE as part of the CFRA procedure to select a plurality of physical random access channel (PRACH) resources and a spatial relation for a PRACH transmission; and
a PRACH index in a second set of bits of the TA field, the PRACH index useable by the UE as part of the CFRA procedure to select a PRACH resource from the plurality of PRACH resources.

21-51. (canceled)
